(19) United States
(12) Patent Application Publication
(10) Pub. No.: US 2016/0140318 A1
(43) Pub. Date: May 19, 2016

(54) MEDICAL ARTIFICIAL INTELLIGENCE SYSTEM

(71) Applicant: Peter Stangel, Piermont, NY (US)

(72) Inventor: Peter Stangel, Piermont, NY (US)

(21) Appl. No.: 14/941,503

(22) Filed: Nov. 13, 2015

Related U.S. Application Data
(60) Provisional application No. 62/079,186, filed on Nov. 13, 2014.

(51) Int. Cl. G06F 19/00; G06F 17/30

(52) U.S. Cl. CPC G06F 19/3481; G06F 19/322; G06F 17/30424; G06F 19/345

(57) ABSTRACT

In an embodiment, a computer implemented software method and system performs medical artificial intelligence with the goal of guiding healthcare toward better health outcomes by learning, by deductive and inferential logic, the clinical interventions that produce, better clinical outcomes and learning, by deductive and inferential logic, the clinical presentations for deployment of theses interventions, on a continuous and ongoing process of tracking, compiling, collating and organizing electronically stored and entered clinical information.

This application is a non-provisional of and claims priority from U.S. Patent Application Ser. No. 62/079,186, filed Nov. 13, 2014, which is incorporated herein by reference in its entirety.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD

The present invention relates in general to the field of medical management systems, and in particular to a system utilizing medical artificial intelligence.

### BACKGROUND

Healthcare has been widely criticized as being high cost for mediocre quality. Medical care and costs for illnesses vary considerably by clinician and by geographical location. Healthcare services have also been criticized for over-utilization as well as under-utilization. High costs may be driven by over-utilization of high cost technology, reliability of evidence-based guidelines and difficulty in determining healthcare outcomes as a function of the healthcare services provided.

It has been problematic to determine the clinical care that represents the most effective healthcare. Evidence-based medicine has been widely used to guide clinical care. Determination of evidence-based medicine has been problematic, dependent on questionable quality of evidence, quality of studies, of limited populations and size, and of complex/unknown variables.

Artificial Intelligence has been an ambition in healthcare information technology. Artificial Intelligence in healthcare could improve the delivery of healthcare services by clinicians, empower laypersons to determine their own healthcare needs and to evaluate the healthcare they receive from clinicians, and to determine the healthcare services that lead to better healthcare outcomes. Artificial Intelligence in healthcare could enable managed care organizations to optimize utilization of healthcare services, to reduce the high costs of healthcare and to guide for the most optimal healthcare.

Artificial Intelligence in healthcare could enable clinicians to better evaluate their patients' clinical status and to render the most appropriate interventions, based on their patients' clinical status, to most effectively treat their patients. Artificial Intelligence could improve healthcare to reduce patient suffering, need for visits to the emergency room and the need for hospitalizations. In the inpatient setting, artificial Intelligence in healthcare could enable clinician to write clinical orders that are most effective to reduce their patients' length of hospital stays and clinical status at the time of discharge.

The deployment of Artificial Intelligence in healthcare has been problematic because of the complexity and variability of clinical medicine. Yet, it has been a long sought after goal.

### SUMMARY

Disclosed are computer-implemented methods and systems for providing a form of Medical Artificial Intelligence, termed M-AI, that can learn and deploy its learning throughout the healthcare arena to yield better healthcare outcomes.

In an embodiment, M-AI learns through processing electronic patients' clinical information into a format that enables side-by-side tracking of changes in the clinical patients' clinical status. In a continuous and ongoing process, M-AI learns the interventions that lead to better improvement in patient clinical status, as well as the clinical presentations associated with these interventions. M-AI deploys its learning widely in healthcare, including for clinicians, laypersons, managed care organizations and other healthcare organizations.

M-AI can deploy its knowledge to recruit and deploy biometric devices to gain information about patients' clinical status to enable remote rendering of healthcare.

### BRIEF DESCRIPTION OF THE DRAWINGS

The foregoing and other objects, features, and advantages of the invention will be apparent from the following more particular description of preferred embodiments as illustrated in the accompanying drawings, in which reference characters refer to the same parts throughout the various views. The drawings are not necessarily to scale, emphasis instead being placed upon illustrating principles of the invention.

FIG. 1 is a flow diagram illustrating an overall method and operation of the invention in accordance with an embodiment thereof.

FIG. 2 is a logic diagram illustrating a process of evaluating clinical data that is electronically entered and/or stored in narrative format programmatically to learn the descriptive clinical finding terms within the narrative format.

FIG. 3 is a flow diagram illustrating an M-AI Clinical Hierarchy and its process of learning clinical terms and their proper level in the Clinical Hierarchy.

FIG. 4 is a flow diagram illustrating M-AI's Clinical Hierarchy and its process of learning clinical terms and their proper level in the Clinical Hierarchy when narrative string searches return no match in the Clinical Hierarchy Clinical Parameter level.

FIG. 5 is a flow diagram illustrating M-AI's Clinical Hierarchy and M-AI's process of learning clinical terms and their proper level in the Clinical Hierarchy when narrative string searches return no match in the Clinical Hierarchy Clinical Parameter and Clinical Hierarchy Clinical Parameter levels.

FIG. 6 is a flow diagram illustrating an M-AI process of programmatically deducing and learning the clinical interventions that produce better patient clinical outcomes to create Clinical Care Plans (CCP)s.

FIG. 7 is a flow diagram illustrating an M-AI process of programmatically creating more than one Clinical Care Plans (CCP) for a Best Clinical course Set (CCS).

FIG. 8 is a flow diagram illustrating an M-AI process of programmatically creating the same Clinical Care Plan (CCP) for more than one Best Clinical Course Set (CCS). FIG. 8. also illustrates two Best Clinical Course Set's with two different Clinical Hierarchy child-parent relationships.

FIG. 9 is a flow diagram illustrating an M-AI process of programmatically creating multiple Clinical Care Plans (CCP)s for multiple Time Points for a Clinical Course Set (CCS).

FIG. 10 is a flow diagram illustrating an M-AI process of programmatically deducing and learning the clinical interventions that produce better patient clinical outcomes to create Clinical Care Plans (CCP)s, by determining the interval of improvement in clinical outcomes.

FIG. 11 is a flow diagram illustrating an M-AI process of programmatically deducing and learning the clinical interventions that produce better patient clinical outcomes for inpatient hospital clinical courses.

FIG. 12 is a flow diagram illustrating an M-AI process of programmatically creating Clinical Care Plan-Finding Groups for Clinical Care Plans.

FIG. 13A is a schematic block diagram illustrating an M-AI process of deploying its knowledge from its Knowledge Base in its goal of guiding patient care toward better outcomes by showing the relationships between its Clinical Care Plan-Findings Groups (CCP-FG)s, Clinical Care Plans (CCP)s and a patient's clinical findings as documented in an Electronic clinical Chart Note (ECCN).

FIG. 13B is a flow diagram illustrating an M-AI process of deploying its knowledge from its Knowledge Base in its goal of guiding patient care toward better outcomes by searching its Knowledge Base for Clinical Care Plan-Findings Group(s) that most closely match an individual's clinical status at a Point in Time (Time Point).

FIG. 14 is a flow diagram illustrating an M-AI process of using inferential logic to combine and create new Clinical Care Plans-Findings Groups (CCP-FG)s using CCP-FGs from its Knowledge Base.

FIG. 15 is a flow diagram illustrating an M-AI process of using deductive and inferential logic to modify Clinical Care Plans in its Knowledge Base.

FIG. 16 is a flow diagram illustrating an M-AI process of creating new Clinical Care Plans in its Knowledge Base, by combining existing Clinical Care Plans and linking Clinical Care Plans' Plans to diagnoses.

FIG. 17 is a flow diagram illustrating an M-AI process of deploying the knowledge from M-AI's Knowledge Base by guiding users in formulating clinical diagnoses for patients at Time Point, as a function of a patient's clinical status at a Time Point.

FIG. 18 is a flow diagram illustrating an M-AI process of deploying the knowledge from M-AI's Knowledge Base to guide clinician evaluation and better understanding of a patient's clinical presentation when writing or reviewing Electronic Clinical Chart Notes (ECCN).

FIG. 19 is a flow diagram illustrating an M-AI process of programmatically evaluating the clinical status of a patient and implementing the Clinical Care Plans that are returned as a result of the clinical evaluation during an Electronic Healthcare Encounter (EHE).

FIG. 20 is a flow diagram illustrating an M-AI process of programmatically aiding clinicians in the writing and review of entries in “Doctor Orders” when rendering patient care.

FIG. 21 is a flow diagram illustrating an M-AI process of programmatically offering layperson guidance by evaluating the clinical status of the person, for whom guidance is sought, and displaying guidance, by implementing the Clinical Care Plans that are returned as a result of the clinical evaluation.

FIG. 22 is a flow diagram illustrating an M-AI process of programmatically enabling laypersons to evaluate the healthcare rendered to them or their family by healthcare professionals in clinical patient-clinician encounters.

FIG. 23 is a flow diagram illustrating an M-AI programmatic process for preservice authorization for a Color Doppler echocardiogram for three different members.

FIG. 24 is a flow diagram illustrating an M-AI programmatic process for concurrent authorization request for an acute Hospital Admission for three members.

FIG. 25 is a flow diagram illustrating an M-AI process for programmatically performing and/or guiding MCO Case Management in a member with the diagnosis of congestive heart failure (CHF) who is being monitoring over multiple time points.

### DETAILED DESCRIPTION

Reference will now be made in detail to the preferred embodiments of the present invention, examples of which are illustrated in the accompanying drawings. The following description and drawings are illustrative and are not to be construed as limiting. Numerous specific details are described to provide a thorough understanding. However, in certain instances, well-known or conventional details are not described in order to avoid obscuring the description. References to one or an embodiment in the present disclosure are not necessarily references to the same embodiment; and, such references mean at least one.

Reference in this specification to “an embodiment” or “the embodiment” means that a particular feature, structure, or characteristic described in connection with the embodiment is included in at least an embodiment of the disclosure. The appearances of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The present invention is described below with reference to block diagrams and operational illustrations of methods and devices for performing medical artificial intelligence. It is understood that each block of the block diagrams or operational illustrations, and combinations of blocks in the block diagrams or operational illustrations, may be implemented by means of analog or digital hardware and computer program instructions. These computer program instructions may be stored on computer-readable media and provided to a processor of a general purpose computer, special purpose computer, ASIC, or other programmable data processing apparatus, such that the instructions, which execute via the processor of the computer or other programmable data processing apparatus, implements the functions/acts specified in the block diagrams or operational block or blocks. In some alternate implementations, the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

This computer implemented software method and system, termed M-AI, learns and implements the health care interventions that lead to better patient healthcare outcomes by learning from a large patient population, in a continuous and ongoing process, the most effective interventions for better healthcare outcomes and to widely deploy this learned knowledge widely in the healthcare arena.

M-AI deploys its learned knowledge for better healthcare outcome as a function of individuals' clinical presentation or status at a point in time.

This ability to electronically learn the best interventions and to deploy these interventions as a function of clinical assessment of individual persons for better healthcare outcomes comprises medical artificial intelligence for healthcare.

M-AI deploys its knowledge from its Knowledge Base in its goal of guiding and implementing patient care toward better outcomes, by learning which clinical interventions are associated with improvement in patient clinical status over time.

M-AI identifies terms that describe or assess aspects of an individual's clinical status order to determine the individual's clinical status. M-AI considers these descriptions or assessments to be clinical finding terms and these include symptoms, clinician examination findings, individual self-assessments, biometric inputs and assessments, laboratory values and diagnostic report assessments.

Clinical finding terms may be presented electronically in narrative format. M-AI parses clinical narrative to identify clinical finding terms by looking for clinical finding indicators, which are words or phrases that identify a clinical finding. M-AI considers clinical finding indicators to include a verb followed by a noun, a description of severity, color adjective, any term denoting a change in clinical status, a description of size, a description of duration, an “=” sign, a time of occurrence, the word “equals” or “equal” and numerical value. M-AI considers narrative terms describing normal clinical status such as “WNL” and “normal” as being clinical findings. M-AI determines improving outcome by comparing the clinical findings across a patient's clinical course noting a return toward normal of the clinical findings, such as less severity, a return of a numerical value toward normal or the designation “WNL”.

M-AI organizes the parsed clinical narrative sentence or narrative string by M-AI's Clinical Hierarchy, which is stored in its Knowledge Base. M-AI's Clinical Hierarchy is a non-linear branching tree hierarchy and consists of 4 branching levels which, from the top level to lowest level are: Clinical Element, Clinical System, Clinical Parameter and Clinical Finding levels. A clinical term in a higher level of the Clinical Hierarchy is the parent of a clinical term in the next lower level.

After parsing and identifying a clinical finding, M-AI searches its Knowledge Base for the parsed clinical finding. If M-AI returns a match, M-AI also returns the parent Clinical Hierarchy Parameter term and its parent Clinical Hierarchy System term. If M-AI finds these Clinical Hierarchy terms in the narrative sentence or string, M-AI replaces and formats this narrative sentence or string with the Clinical Hierarchy Clinical System followed by the Clinical Hierarchy Clinical Parameter followed by the Clinical Hierarchy Clinical Finding.

If a narrative sentence or string contains more than one clinical finding and these clinical findings have the same Clinical Hierarchy Parameter term and the same Clinical Hierarchy System term, M-AI concatenates the Clinical Hierarchy clinical findings term to the same Clinical Hierarchy Parameter term and the same Clinical Hierarchy System term. Otherwise, M-AI replaces and formats the narrative sentence or string with each Clinical Hierarchy clinical findings term with its own Clinical Hierarchy Parameter term and the same Clinical Hierarchy System term.

If the M-AI search in its Clinical Hierarchy Clinical Findings level returns no matches for a narrative clinical finding, M-AI creates a new Clinical Hierarchy clinical findings term.

M-AI then reviews the noun or nouns immediately preceding and immediately following the clinical finding within the narrative sentence or narrative string (Proximate Nouns) to determine the parent Clinical Hierarchy Clinical Parameter and the parent Clinical Hierarchy Clinical System. M-AI replaces and formats this narrative sentence or string with the Clinical Hierarchy Clinical System followed by the Clinical Hierarchy Clinical Parameter followed by the new Clinical Hierarchy Clinical Finding.

If the narrative sentence's or string consists of more than one Proximate Noun and no matches have been returned, M-AI searches each Proximate Noun or combinations of nouns in the narrative sentence or string for matches at its Clinical System level. If a match is returned, M-AI places the partial match at the Clinical System level and the remainder of the Proximate Nouns at the Clinical Parameter level.

If the narrative sentence's or string consists of more than one Proximate Noun and no matches have been returned, M-AI searches each Proximate Noun or combinations of nouns in the narrative sentence or string for matches at its Clinical System level. If a match is returned, M-AI places only the clinical Proximate Noun or Proximate Nouns that are not part of this search at the Clinical Parameter level.

If no match is returned, M-AI uses the Proximate Noun or combinations of nouns in the Proximate Nouns for partial matches at its Clinical Parameter level. If a match is returned, M-AI places the Proximate Nouns remaining noun or nouns at the Clinical System level. M-AI modifies the partially matched Clinical Parameter terms by deleting the matched noun(s) from each Clinical Parameter term.

If no match is returned at both the Clinical Hierarchy Clinical Parameter level and the Clinical Hierarchy Clinical System level, M-AI places the Proximate Nouns at the Clinical Parameter level.

M-AI determines the Clinical Hierarchy Clinical Element level of the narrative Clinical Finding by determining its Clinical Hierarchy Clinical Parameter level and its Clinical Hierarchy Clinical System level and/or by its location in the user electronic interface screen.

M-AI saves Clinical Hierarchy modifications to its Knowledge Base.

M-AI programmatically compiles, collates and organizes clinical information in patient databases on a continuous and ongoing process to create groups of clinical findings that are handled as clinical units that M-AI deploys in order to assess the clinical presentation or clinical status of individual persons at points in time (Time Point)s and to gain specific clinical information from users about clinical presentation or clinical status to guide healthcare toward better healthcare outcomes.

M-AI organizes each clinical finding in the clinical units into a four level non-linear branching Clinical Hierarchy. M-AI terms these clinical units, with their clinical findings organized by Clinical Hierarchy, Care Plan-Findings Groups (CCP-FG)s.

M-AI deploys CCP-FGs to assess the clinical presentation or clinical status of individual persons at points in time (Time Point)s, according to individual persons' demographics, and to gain specific clinical information from users about clinical presentation or clinical status.

M-AI programmatically compiles, collates and organizes clinical information in patient databases on a continuous and ongoing process to create clinical courses for individual persons as a function of the individual persons' clinical information. A clinical course is a timeline consisting of individual persons' clinical information organized by Time Points and by CCP-FGs.

M-AI programmatically groups clinical courses with the same or similar initial Time Point CCP-FGs, by demographics, into Clinical Course Sets (CCS)s. M-AI programmatically determines the Clinical Course Sets that show the best improvement in their initial CCP-FG's clinical findings.

M-AI determines improvement in clinical findings by comparing each clinical finding in each CCP-FG across the dates and times (Time Points) of Clinical Course Sets. M-AI determines improvement in clinical findings by means such as a return toward normal of a clinical finding, such as decreased severity, a return of a numerical value toward normal or the designation “WNL”.

M-AI programmatically identifies the best clinical interventions, between and at Time Point CCP-FGs, for each best Clinical Course Set, as Clinical Care Plans linked to the Time Point CCP-FGs.

M-AI creates unique CCP-FG internal code numbers. M-AI labels CCP-FGs' with the diagnoses in the clinical information at their Time Points. M-AI designates CCP-FGs' with the diagnoses' universal ICD (International Classification of Disease) codes.

M-AI deploys CCP-FGs by searching M-AI's Knowledge Base that most closely match individual persons' clinical presentation or clinical status in order to deploy the Clinical Care Plans of the CCP-FGs returned by the search. M-AI deploys CCP-FGs in order to gain specific additional clinical information, as Request(s) For Information (RFI)s, about the clinical presentation or clinical status from users and deploy the user responses to gain additional clinical information for refining further repeated CCP-FGs searches.

M-AI deploys its knowledge in its Knowledge Base as returned Care Plan-Findings Groups (CCP-FG)s with their linked Clinical Care Plans (CCP)s throughout the healthcare arena. M-AI deploys CCP-FGs and linked CCPs for clinician users during clinical patient-clinician encounters for guiding clinician evaluation of patient evaluation, formulating diagnoses and formulating care for the patient.

M-AI deploys M-AI deploys CCP-FGs and linked CCPs to programmatically implement and execute CCPs for patients. CCP Plans which can be performed only by licensed clinicians are presented to an appropriately licensed clinician, who is typically remotely located from the patient, for sign off prior to execution of the CCP Plans.

M-AI deploys M-AI deploys CCP-FGs and linked CCPs to empower laypersons to be able to better evaluate their own and their family members' health status and to make better determinations about their healthcare. M-AI empowers laypersons to be able to evaluate the healthcare delivered by their healthcare providers.

M-AI deploys M-AI deploys CCP-FGs and linked CCPs for Managed Care Organizations (MCO)s to guide member utilization of healthcare services, payment claims for healthcare services, Quality Care Reviews and Case Management of members with complex healthcare needs.

M-AI programmatically compiles, collates and organizes clinical information in patient databases on a continuous and ongoing process to determine the interventions that produce improved health outcomes by comparing the interventions in the best Clinical Course Sets.

M-AI creates subsets of each best Best Clinical Course Set, grouping the subsets by same or similar interventions by interventions between and/or at Time Points in the Clinical Course Set. M-AI determines the “best” Clinical Course Subset, by its best interventions.

M-AI determines the best interventions by means such as the fewest number of interventions between and/or at CCP-FG Time Points, the invasiveness of the interventions and the cost of the interventions. Additionally, M-AI considers possible adverse effects of these interventions, by a search of its Knowledge Base for CCP-FGs in any Clinical Course Set that have worsened after the interventions.

M-AI groups the one or more interventions between and/or at CCP-FG Time Points as Intervention Sets and links each Intervention Set to the CCP-FG at the first Time Point preceding the Intervention Set or at the CCP-FG at the Time Point of the Intervention Set.

M-AI deduces and learns these best Intervention Sets for each best Clinical Course Set to create Clinical Care Plans (CCP)s, each CCP consisting of an Intervention Set and each CCP linked to its CCP-FG Time Point. M-AI may create multiple CCPs for multiple Time Points in each best Clinical Course Set.

M-AI stores its learned knowledge, the Clinical Care Plans with their linked CCP-FGs in M-AI's Knowledge Base.

In a similar manner, M-AI also learns and stores the interventions that produce worsening of Initial Findings Sets. M-AI stores this learned knowledge in M-AI's Knowledge Base.

A computer implemented software method and system that performs medical artificial intelligence (M-AI) with the goal of guiding healthcare toward improved health outcomes by comparing patients with similar initial clinical findings and examining in a continuous and ongoing process the attributes of their patient-clinician encounters, such as the type and frequency of the patient-clinician encounters (e.g. office visit, ER visit).

M-AI learns the interventions associated with fewer patient-clinician encounters, lower intensity patient-clinician encounters and longer intervals between encounters. M-AI learns the interventions associated with fewer or no emergency room (ER) encounters, fewer or no hospital admissions.

A computer implemented software method and system that performs medical artificial intelligence (M-AI) with the goal of guiding healthcare toward better health outcomes by comparing patients who are admitted to an hospital facility with similar clinical findings and comparing the attributes of their inpatient hospital inpatient clinical courses such as lengths-of-stay, bed level-of-care and destination upon discharge. M-AI learns the more optimal patient hospital courses by noting a shorter level of stay, lower bed level-of-care (e.g. med-surg bed vs ICU bed). M-AI learns patient clinical improvement by noting discharge destination (discharge to home, discharge to another facility—e.g rehabilitation, long term acute care hospital (-LTACH). M-AI learns the interventions associated with more optimal patient hospital inpatient courses.

M-AI deploys its knowledge from its Knowledge Base in its goal of guiding and implementing patient care toward better outcomes, by clinicians in patient-clinician encounters to enhance the clinical evaluation and guide the planning and delivery of healthcare of their patients.

M-AI deploys its knowledge from its Knowledge Base in its goal of guiding and implementing patient care toward better outcomes, by clinicians in patient-clinician encounters to enhance the clinical evaluation and guide the planning and delivery of healthcare of their patients. M-AI deploys Clinical Care Plan-Findings Groups (CCP-FG)s and Clinical Care Plans (CCP)s during clinician-user Electronic Clinical Chart Note (ECCN) recording or review of clinical patient-clinician encounters.

M-AI deploys CCP-FGs to enable the clinicians to review the clinicians' evaluation of patients' clinical status in clinical patient-clinician encounters, by guiding clinician's EECN entered clinical information for clinical consistency of clinicians' clinical findings with clinicians' diagnoses in the EECN “Impressions” section, for clinical consistency of clinicians' clinical findings with clinicians' EECN healthcare plans as entered in the ECCN “Assessment & Plans” section and for clinical consistency of clinicians' EECN healthcare plans with clinicians' EECN diagnoses.

M-AI deploys CCP-FGs to guide clinicians' in review of differential diagnoses of the patient's clinical evaluation and clinicians determination of diagnosis entries in the ECCN “Impressions” section.

M-AI deploys CCP-FGs to prompt clinicians for additional patient clinical information needed to support clinicians' diagnoses entered in the EECN “Impressions” section or to support a diagnosis in the differential diagnosis list.

M-AI deploys CCPs to guide clinicians' planning of patients' healthcare actions to be rendered as a result of clinical patient-clinician encounters. M-AI deploys CCPs to aid clinicians in the planning of healthcare actions in the ECCN “Assessment & Plans” section, by deploying CCP Plans for clinicians' review and selection.

M-AI deploys its knowledge from its Knowledge Base by searching its Knowledge Base for the CCP-FG's which most closely match patient's clinical presentations as recorded in ECCNs. M-AI parsing each ECCN clinical detail for its clinical findings, organizes the clinical detail by M-AI's Clinical Hierarchy and collates all the details into a Clinical Status Data Set. M-AI searches its Knowledge Base for the CCP-FG's that most closely match the Clinical Status Data Set. M-AI deploys the returned CCP-FGs and their CCPs for clinician guidance.

A method and system computer software that performs medical artificial intelligence with the goal to guide healthcare toward improved health outcomes by deploying computer learned knowledge for laypersons to assess their own clinical status, independent of clinician caregivers, and to deploy this clinical status assessment to implement healthcare actions to improve their health outcomes, independent of clinical patient-clinician direct encounters. Healthcare actions requiring performance by licensed clinicians may be signed off by remotely situated clinicians, who are appropriate licensed.

M-AI guides layperson clinical status assessment and healthcare implementation by M-AI's Electronic Healthcare Encounter (EHE) process. The Electronic Healthcare Encounter may take place in the laypersons-user's home or in an outside location. The layperson-user is now an EHE patient.

M-AI guides layperson-user in acquiring the clinical information to assess the layperson-user's clinical status at a point in time (Time Point), typically a current date and time. M-AI organizes the acquisition of clinical information by acquiring clinical details in an arrangement that resembles the format of an Electronic Clinical Chart Note and displays the clinical details in an Healthcare Encounter Note (EHEN) which resembles the format of an Electronic Clinical Chart Note, with sections such as Chief Complaint, Present Illness, Exam, Lab and Diagnostics.

M-AI acquires the layperson-user's clinical details differently for each EHEN section. M-AI parses all acquired clinical details in narrative form to extract clinical findings. M-AI organizes each acquired clinical detail into clinical findings by its Clinical Hierarchy format and collates EHEN clinical findings into a Clinical Data Set.

M-AI acquires the layperson-user's clinical details differently for each EHEN section. M-AI creates a Clinical Data Set by processing clinical information as it is acquired, formatting each clinical detail by M-AI's Clinical Hierarchy. After each update in the EHEN Clinical Data Set, M-AI searches its Knowledge Base for the Clinical Care Plan-Findings Groups (CCP-FG)s that most closely match the Clinical Data Set update, in order to guide the lay-person for further acquisition of additional clinical details of the layperson-user's clinical status.

M-AI initiated the Electronic Healthcare Encounter by presenting the layperson-user with a request for information about the reason for the EHE. The layperson-user response is Clinical Hierarchy formatted into the Clinical Data Set and entered in the Electronic Healthcare Encounter Note (EHEN) under the Chief Complaint section.

M-AI performs a Knowledge Base CCP-FGs that most closely match the Clinical Data Set. M-AI processes and collates the returned CCP-FGs to formulate Requests For Information about layperson-user symptoms to acquire details about the layperson-user's Present Illness. Each layperson-user response to an RFI is Clinical Hierarchy formatted, added to the Clinical Data Set and entered in the EHEN under the Present Illness section. M-AI may reformulate RFIs after each layperson-user response.

M-AI completes the Present Illness acquisition of clinical information when repeated searches of its Knowledge Base for matches to the Clinical Data Set do not return fewer findings and/or after the layperson-user has responded to all RFI's.

M-AI programmatically acquires the clinical details requirements for the layperson-user's EHE examination by deploying the Clinical Data Set which contains the clinical findings of the Chief Complaint and Present Illness EHE sections. M-AI performs a Knowledge Base CCP-FGs that most closely match the Clinical Data Set.

M-AI programmatically determines the biometric devices needed to yield the required clinical details for the EHE Exam section. Biometric devices include such devices as the electronic stethoscope, blood pressure monitor, electronic thermometer, pulse monitor, cardiac rhythm monitor, electronic scale, pulse oximeter, monitors of blood chemistries, such as blood sugar monitors, hemoglobin monitor. Biometric devices may also include pressure transducers, thermal sensors, cameras and image analyzers and ultrasound scanners.

M-AI informs the layperson-user of the required biometric devices and how to deploy each biometric device for exam.

Each biometric device reading and/or reading assessment is Clinical Hierarchy formatted, added to the Clinical Data Set and entered in the EHEN under the Exam section. M-AI may reformulate the required biometric devices after each biometric device reading. M-AI may reformulate the RFIs for Present Illness details' after each biometric device reading.

M-AI programmatically downloads the layperson-user's available appropriately recent laboratory data and diagnostic test results. Each downloaded lab and diagnostic result is Clinical Hierarchy formatted, added to the Clinical Data Set and entered in the EHEN under its appropriate EHE section of Lab or Diagnostics.

M-AI programmatically parses and organizes each laboratory data and diagnostic test result by M-AI's Clinical Hierarchy to add to the Clinical Data Set. M-AI may reformulate the RFIs for Present Illness details or the required biometric devices after downloads.

M-AI determines completion of the layperson-user's clinical information acquisition when repeated searches of its Knowledge Base for matches to the Clinical Data Set do not return fewer CCP-FGs and/or after the layperson-user has responded to all RFI's, the layperson-user has deployed all required biometric devices, and after lab and diagnostic test downloads have been done.

When M-AI's Knowledge Base search returns a single CCP-FG, M-AI deploys the Clinical Care Plan (CCP) of the returned CCP-FG to implement healthcare for the layperson-user. Implementation includes a “Suggested Actions Advisory” that informs the layperson-user of layperson healthcare actions to be taken, such as over-the-counter medication use, dietary modifications, respiratory care actions, physical therapy exercises and consultations to be sought. M-AI may offer details about each Suggested Actions Advisory list item in the Suggested Actions Advisory list, when selected by the layperson-user, explaining such details as instructions how to perform the Guidance list item, frequency of performance. M-AI may execute the CCP Plans that do not require professional licensure, after layperson-user sign off. M-AI may offer other medical information about the person's clinical status. M-AI deploys the diagnosis of the final CCP-FG returned to display information about the diagnosis.

M-AI may execute the CCP Plans that do require professional licensure, only after sign off by a licensed clinician, who is typically remote to the layperson-user and then after layperson-user sign off. CCP Plans that do require professional licensure may include medications to be prescribed or ordered, lab tests to be ordered, procedures to be ordered and interfacing with robotic procedure (surgical) devices.

If M-AI's Knowledge Base search returns more than one CCP-FG, M-AI alerts the layperson-user of the fact that specific healthcare action cannot be advised and taken. M-AI does enable the layperson-user to review the possible sets of healthcare actions that are available for each returned CCP-FG. The layperson-user may save M-AI's sets of possible healthcare actions along with the EHE for review by a clinician.

If M-AI's Knowledge Base search returns no CCP-FG, M-AI alerts the layperson-user of the M-AI has inadequate clinical information to advise healthcare actions.

M-AI deploys its knowledge from its Knowledge Base by its Electronic Healthcare Encounter (EHE) process to be able to render healthcare to individual persons at any geographic location, including remote, distant impoverished and medical professional understaffed locations on earth.

M-AI deploys its knowledge from its Knowledge Base by its Electronic Healthcare Encounter (EHE) process to be able to render healthcare in the outpatient setting as well as the inpatient setting.

M-AI deploys its knowledge from its Knowledge Base in its goal of guiding and implementing patient care toward better outcomes, by deploying Clinical Care Plan-Findings Groups and Clinical Care Plans to guide clinicians in the writing and review of Doctor Orders which are clinically consistent with patients' clinical status.

M-AI programmatically assess patients' clinical status at the point in time (Time Point) when clinicians write Doctors Orders for patients. Doctors Orders can be either inpatient or outpatient locations of care.

M-AI assesses the patients' clinical status for whom clinicians are writing Doctors Orders by searching Patient Data Bases for patients' most recent clinical information at the Time Point of clinicians are making entries into Doctors Orders. M-AI processes the clinical information for a patient to create a Clinical Status Data Set. M-AI searches its Knowledge Base for CCP-FG matches to the Clinical Status Data Set.

Alternately, M-AI may perform a Knowledge Base search as a function of a clinician-user's entry of a diagnosis or as a function of a clinician-user's selection of a displayed ECCN diagnosis.

M-AI deploys the returned CCP-FG's Clinical Care Plan(s) for display to enable clinician writing and review of entries in Doctor Orders at the Time Point. If multiple CCP-FGs are returned, M-AI displays the CCP Plans for each CCP-FG by the CCP-FG's diagnosis.

M-AI enables a clinician-user to select one or more CCP Plans for entry into Doctors Orders. M-AI enables clinician-user selection to review the orders in Doctors Orders for clinical consistency with the patient's clinical presentation, either by patient's clinical findings or patient diagnoses. M-AI

M-AI enables a clinician-user to select one or more CCP Plans for entry into Doctors Orders. M-AI enables a clinician-user to review the orders in Doctors Orders for clinical consistency with the patient's clinical status, as determined by clinician-user selection the patient's clinical findings or diagnoses. M-AI annotates each individual order in Doctors Orders with a characters denoting clinical status consistency, such as a “✓” for consistency and “#” for inconsistency.

M-AI deploys its knowledge from its Knowledge Base in its goal of guiding and implementing better healthcare outcomes by guiding laypersons in their own healthcare decision-making.

M-AI enables laypersons to make better healthcare decisions for themselves and their family members by its Electronic Healthcare Guidance (EHG) programmatic process.

M-AI's EHG process is similar to M-AI's Electronic Healthcare Encounter process (EHE). M-AI assesses the clinical status of a layperson or family member to offer guidance about the healthcare actions that the layperson should take to address the person's clinical status. M-AI may also offer background medical information to offer the layperson better understanding about the person's clinical status.

M-AI programmatically performs the person's clinical status assessment by acquiring clinical information that describes the person's clinical status at the point in time (Time Point) of the EHG. M-AI's EHG process acquires the details of the person's clinical status in a similar manner to M-AI's EHE process, deploying requests for information from the layperson and any available biometric device outputs and assessments. M-AI similarly organizes the information into a Clinical Data Set. M-AI deploys an Electronic Healthcare Guidance Note (EHGN) to display the Clinical Data Set, formatted by note section.

M-AI's EHG clinical status assessment process differs from EHE process by starting with a request for information about the reason for the EHG, by deploying requests for information for Exam details which are not available from available biometric devices and by deploying requests for information for Lab and Diagnostic results details. M-AI processes and organizes each clinical information by its clinical Hierarchy to add to the Clinical Data Set.

Similarly to M-AI's EHE search process, M-AI's EHG performs serial searches for CCP-FG that match the Clinical Data Set at each increment or modification of the Clinical Data Set. M-AI processes the results of the EHG search process to display one or more Guidance lists derived from the returned Clinical Care Plan-Findings Group(s) finally returned. The Guidance list is similar to EHEN's Suggested Actions Advisory.

Unlike M-AI's EHEN, M-AI's EHG does not offer a Professional Actions Advisory. M-AI may include advice to seek healthcare from a clinician in the Guidance list. M-AI may offer multiple sets of guidance if the final search returns multiple CCP-FG's. M-AI may offer no guidance if the final search returns no CCP-FG's

M-AI may offer details about each Guidance list item in the Guidance list, when selected by the layperson-user, explaining such details as instructions how to perform the Guidance list item, frequency of performance. M-AI may offer other medical information about the person's clinical status. M-AI deploys the diagnosis (diagnoses) of the final CCP-FG(s) returned to display information about the diagnosis (diagnoses).

M-AI deploys its knowledge from its Knowledge Base in its goal of guiding and implementing patient care toward better outcomes, by enabling laypersons to evaluate the healthcare rendered to them and their family by their healthcare professionals in clinical patient-clinician encounters. A layperson can evaluate the rendered healthcare including medications prescribed, laboratory ordered, diagnostic tests ordered and procedures ordered done or done recommended by their healthcare professionals.

M-AI performs this rendered healthcare evaluation as a Doctor's Care Review Note (DCRN). M-AI programmatically performs the rendered healthcare evaluation by acquiring information from the layperson-user about details of the layperson's or family member's clinical patient-clinician encounter.

M-AI acquires the information by first presenting the layperson-user with a request for information about the reason for the visit to the healthcare professional (clinician). M-AI parses the layperson-user response for clinical findings and places the clinical findings in its Clinical Hierarchy format to create a Doctor Care Review Data Set. M-AI then searches its Knowledge Base for Clinical Care Plan Findings Groups (CCP-FG)s that match the Doctor Care Review Data Set.

M-AI then deploys the returned CCP-FGs to create a request for information (RFI) list to prompt the layperson-user for details of the encounter, which may include the diagnosis (diagnoses) that the clinician has given to the patient, the medications prescribed, laboratory ordered, diagnostic tests ordered and procedures ordered done or done.

M-AI programmatically parses each layperson-user response to an RFI item and organizes the parsed clinical findings by Clinical Hierarchy format to add to the Doctor Care Review Data Set. M-AI repeats the CCP-FG search with each update in the Doctor Care Review Data Set for possible modification of the RFI list.

M-AI enters each Clinical Hierarchy-formatted layperson-user response into the Doctor's Care Review Note.

M-AI enables the layperson-user to evaluate the healthcare rendered by the clinician, as entered in the DCRN, in several different ways, depending on layperson-user choice or review. M-AI deploys its knowledge from its Knowledge Base, by searching M-AI's for CCP-FGs that match the Doctor Care Review Data Set, to display in the DCRN which DCRN specific rendered healthcare items M-AI considers clinically appropriate for the patient's care as well as which DCRN specific rendered healthcare items that M-AI considers clinically inappropriate care.

M-AI enables the layperson-user to evaluate the rendered healthcare as a function of the clinician's diagnosis, as well as the patient's reason(s) for the clinical patient-clinician encounter. M-AI also enables the layperson-user to evaluate the rendered healthcare as a function of any diagnosis the lay-person for which the lay-person wants to review the rendered care.

M-AI also enables the layperson-user to deploy a completed Electronic Healthcare Guidance Note (EHGN) to evaluate the rendered healthcare. M-AI deployment of the of the clinical information in the EGIN (Clinical Data Set) enables M-AI to make the best evaluation of the rendered healthcare in the clinical patient-clinician encounter.

If the layperson-user has chosen to do the rendered healthcare evaluation by the clinician's diagnosis, M-AI searches its Knowledge Base by CCP-FGs' diagnosis. If the layperson-user has chosen to do the rendered healthcare evaluation by the reason(s) for the clinical patient-clinician encounter, M-AI searches its Knowledge Base for CCP-FGs that match Clinical-Hierarchy formatted reasons. If the layperson-user has chosen to do the rendered healthcare evaluation by deploying the EHGN Clinical Data Set, M-AI searches its Knowledge Base for CCP-FGs that match the Clinical Data Set.

M-AI then deploys the Clinical Care Plan(s) of the returned CCP-FGs to programmatically evaluate the DCRN. M-AI annotates each DCRN specific rendered healthcare item that is CCP-consistent with a character such as “✓”. M-AI annotates each DCIN Care healthcare item that is not included in the CCP Plans with a character such as “#”.

M-AI deploys its knowledge from its Knowledge Base in its goal of guiding and implementing patient care toward better outcomes, by assisting Managed Care Organizations (MCO)s and other healthcare review organizations in guiding clinical care rendered. MCOs are tasked with overseeing their members' healthcare. In order to do so, MCO medical directors and nurses review and make determinations about the healthcare services for to their members. Medical directors and nurses can authorize healthcare services that are done preservice, concurrently and/or post service. Only medical directors can deny healthcare services.

M-AI assists MCOs in the review of healthcare services provided to their members by programmatically reviewing their members' clinical status and reviewing healthcare services requested by healthcare providers to programmatically authorize healthcare services that are medically necessary. M-AI refers healthcare services that are not medically necessary to medical directors for determination.

M-AI reviews the requested healthcare service for a member for medical necessity by first assessing the member's clinical status by searching its member databases for clinical information about the member at the point in time (Time Point) of the healthcare service request. The clinical information include Electronic Clinical Chart Notes (ECCN)s, biometric device inputs and assessments, laboratory and diagnostic test reports, medications history, therapeutic notes, and claims payments for services rendered. M-AI parses the clinical information and organizes the clinical information by M-AI's Clinical Hierarchy into a Clinical Status Data Set.

M-AI searches its Knowledge Base for the CCP-FGs that most closely match the Clinical Status Data Set. M-AI deploys the CCP-FGs' CCP Plans to search for the healthcare service requested by the provider. If the search returns a CCP match for the healthcare service, M-AI programmatically authorizes the healthcare service. If the search returns no CCP match, M-AI refers the requested to the medical director for determination.

Alternately, instead of programmatically authorizing medical necessity or a requested healthcare service, M-AI may guide the medical director or nurse in making a healthcare service medical necessity determination by displaying the member's clinical status and CCP Plans resulting from M-AI's CCP-FG search in a Healthcare Service Assessment Note.

In a process similar to medical necessity review, M-AI can review member clinical status for payment of health provider claims for healthcare services rendered. M-AI may programmatically authorize payment, or advise payment determination, for healthcare services.

In a process similar to medical necessity review, M-AI deploys its knowledge from its Knowledge Base to guide MCO nurses in Clinical Case management of MCO members with complex medical illnesses. M-AI displays the member's clinical status and CCP Plans resulting from M-AI's CCP-FG search in a Case Management Note. The nurse deploys this information when speaking to the member to guide the member toward a better healthcare outcome.

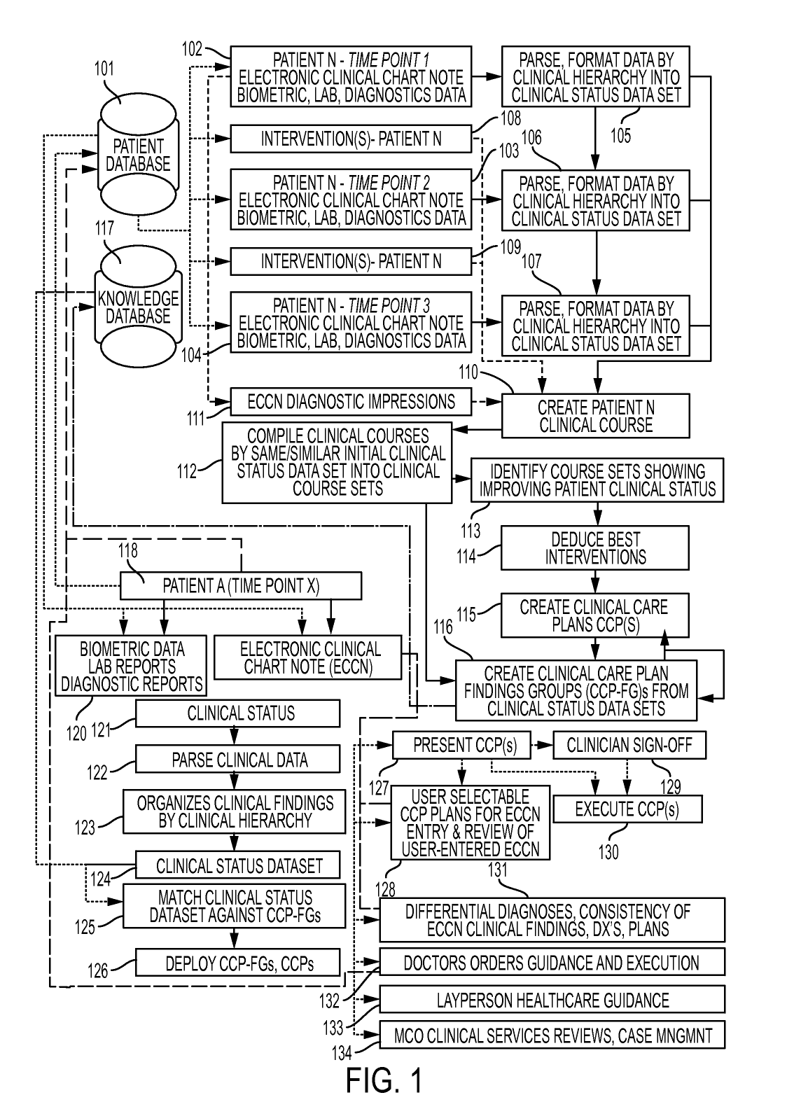

FIG. 1 illustrates an overall method and operation of the Medical Artificial Intelligence (M-AI) system. The method and operation of the Medical Artificial Intelligence (M-AI) system can be performed on a server computer, stand-alone computer or mobile devices such as mobile computer devices (e.g., laptops, tablets and smartphones). The computer Patient Databases store patient clinical data, such as Electronic Clinical Chart Notes (ECCN)s, Electronic Health Records (EHR)s, biometric device readings and assessments, lab test reports, diagnostic test reports, medications, procedures, surgeries, other therapies and durable medical equipment M-AI learns and builds its Knowledge Database 101 by the following processes.

M-AI processes the electronically stored and entered clinical information in cascading steps by organizing the clinical information into sets of clinical findings for each person's clinical information and organizing each person's sets' clinical findings, by date and time, into a clinical course timeline.

M-AI programmatically searches for Patient N's clinical data in its Patient Database. M-AI organizes Patient N's clinical data into sets of clinical findings by date and time consisting of Time Points into a timeline format 102, 103, 104.

M-AI organizes the clinical data at each Time Point. M-AI parses and identifies clinical data that is in narrative format to extract distinct clinical terms and clinical findings. M-AI organizes the clinical data by organizing each clinical finding into its Clinical Hierarchy and collating the findings to create a Clinical Status Data Set for each Time Point at steps 105, 106, 107.

M-AI programmatically determines the interventions in Patient N's clinical information and organizes the interventions as Intervention Sets by date and time, and places the Intervention Sets by date and time in Patient N's timeline between, or at, Time Points 108, 109.

M-AI programmatically arranges Time Point Clinical Status Data Sets and timeline Intervention Sets to create a Clinical Course at step 110.

M-AI attaches ECCN Diagnostic Impressions to Time Point Clinical Status Data Sets 111.

M-AI programmatically compiles and collates clinical courses with same or similar initial Clinical Status Data Sets, by patient demographics, into Clinical Course Sets at step 112.

M-AI programmatically determines the Clinical Course Sets that show the best improvement in the clinical findings of their initial Clinical Status Data Sets over their clinical courses to identify best Clinical Course Sets at step 113.

M-AI identifies the clinical interventions in each best Clinical Course Set to deduce the best clinical interventions for each best Clinical Course Set at step 114.

At step 115, M-AI creates one or more Clinical Care Plans (CCP)s for one or more Time Points in each best Clinical Course Set comprised of the Intervention Sets between and/or at the Time Points.

At step 116, M-AI creates Clinical Care Plan-Findings Groups (CCP-FGs) consisting of the Clinical Hierarchy formatted Clinical Status Data Sets at each Time Point and links each CCP-FGs to Clinical Care Plans for its Time Points.

M-AI may modify and create new CCP-FGs and CCPs by inferential logic when reviewing CCP-FGs and CCPs created at steps 115 and 116.

M-AI stores its learned knowledge, comprised of the CCPs, CCP-FGs and Clinical Courses Sets in its Knowledge Database 117.

M-AI deploys its learned knowledge by assessing the clinical presentation or clinical status of an individual person, Patient A, at the Time Point for whom M-AI's guidance is sought 118. The individual person's, Patient A's, clinical presentation or clinical status may consist of information entered at the time of M-AI guidance as in a current Electronic Clinical Chart Note 119.

The individual person's, Patient A's, clinical presentation or clinical status may consist of information downloaded from the Patient Database 120. The individual person's, Patient A's, clinical presentation or clinical status may consist of a combination of ECCN and downloaded clinical information.

At steps 121, 122, 123, 124 M-AI processes the clinical status information to extract clinical terms and clinical findings which are organized by M-AI's Clinical Hierarchy and collated into a Clinical Status Data Set.

At step 125, M-AI deploys its learned knowledge by searching M-AI's Knowledge Database for CCP-FGs that most closely match the individual person's, Patient A's, clinical presentation or clinical status, as processed into the individual person's, Patient A's, Clinical Status Data Set.

At step 126, M-AI deploys the CCP-FG(s) returned by the search and the CCP-FG(s) linked CCPs to guide the individual person's, Patient A's, healthcare.

M-AI may guide the individual person's, Patient A's, healthcare in a variety of ways. For example, M-AI may guide clinicians in patient-clinician encounters to enhance clinical evaluation and guide planning and delivery of healthcare.

At steps 127, 128 M-AI deploys CCPs to aid clinicians in the planning of healthcare actions in the ECCN “Assessment & Plans” section, by deploying CCP Plans for clinicians' Plans entry and review.

At steps 129, 130, M-AI may deploys CCP(s) for programmatic execution of CCP Plans, after licensed clinician sign off for Plans which can be only performed by licensed clinicians.

At step 131, M-AI deploys CCP-FG(s) for clinician-user guidance for differential diagnoses, for consistency of ECCN clinical findings with diagnoses, for consistency of clinician Plans for healthcare actions with ECCN clinical findings and diagnoses.

At step 132, M-AI deploys CCP-FG(s) and CCP(s) for user-clinician guidance when writing Doctors Orders and for consistency of Doctors Orders entries with patient clinical status. M-AI deploys CCP-FG(s) and CCP(s) to programmatically write Doctors Orders, with clinician sign off.

At step 133, M-AI deploys CCP-FG(s) and CCP(s) to empower layperson-users to assess their own clinical status, independent of clinician caregivers, and to implement healthcare actions independent of clinical patient-clinician direct encounters, to make better healthcare decisions and to evaluate the care received from healthcare providers.

At step 134, M-AI deploys CCP-FG(s) and CCP(s) to guide Managed Care Organizations (MCO)s in determining member utilization of healthcare services, payments for healthcare services, Quality Care reviews and nurse Case Management for member's with complex healthcare needs.

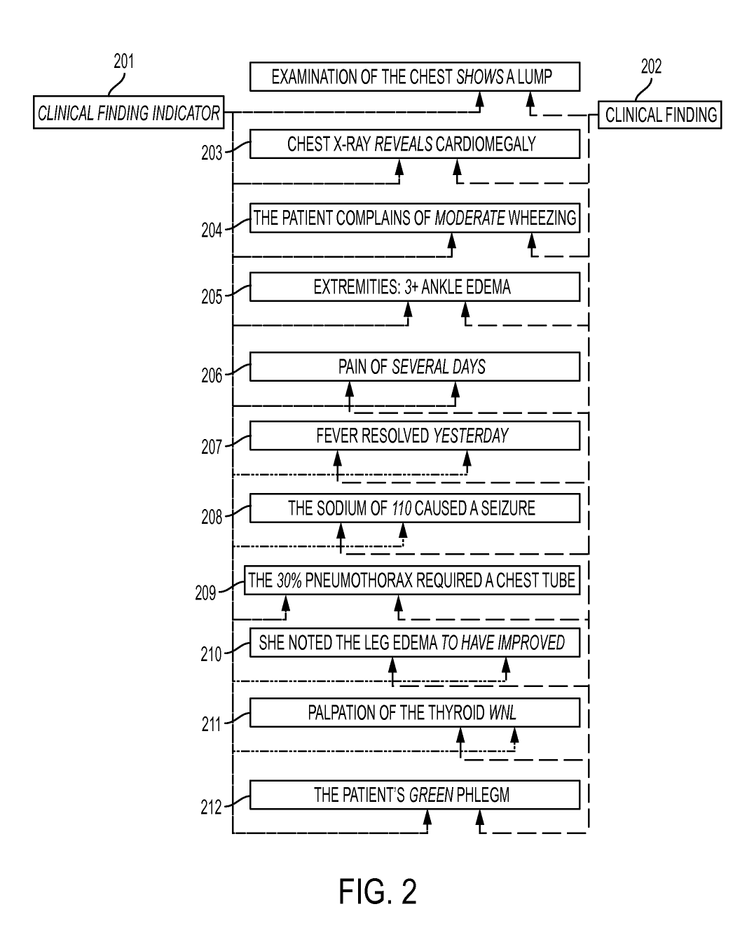

FIG. 2. illustrates the M-AI process of evaluating clinical data that is electronically entered and/or stored in narrative format programmatically to learn the descriptive clinical finding terms within the narrative format. M-AI deploys “Clinical Finding Indicators” 201, which are words or phrases in the narrative string that indicate that an adjoining portion of the narrative string is a descriptive Clinical Finding 202.

At line 203, in the string “Chest x-ray reveals cardiomegaly”, “reveals” is the clinical finding term that indicates that the Clinical Finding is “cardiomegaly”. The word “reveals” is an indicator because it is an antecedent verb.

At line 204, in the string “The patient complains of moderate wheezing”, “moderate” is the clinical finding term that indicates that the Clinical Finding is “wheezing”. The word “moderate” is an indicator because it is a description of severity.

At line 205, in the string “Extremities: 3+ ankle edema”, the phrase “3+” is the clinical finding term that indicates that the Clinical Finding is “ankle edema”. The phrase “3+” is an indicator because it is a description of severity.

At line 206, in the string “Pain of several days”, “several days” is the clinical finding term that indicates that the Clinical Finding is “Pain”. The phrase “several days” is an indicator because it is a term of duration.

At line 207, in the string “Fever resolved yesterday”, “yesterday” is the clinical finding term that indicates that the Clinical Finding is “Fever” and “yesterday” is an indicator because it is a time of occurrence.

At line 208, in the string “The sodium of 110 caused a seizure”, “110” is the clinical finding term that indicates that the Clinical Finding is “sodium” and “110” is an indicator because it is a numerical value.

At line 209, in the string “The 30% pneumothorax required a chest tube”, “30%” is the clinical finding term that indicates that the Clinical Finding is “pneumothorax”. The term “30%” is an indicator because it has a numerical value.

At line 210, in the string “She noted the leg edema to have improved.”, “to have improved” is the clinical finding term that indicates that the Clinical Finding is “cardiomegaly 10”. The phrase “to have improved” is an indicator because it is a term denoting change in clinical status.

At line 211, in the string “Palpation of the thyroid WNL”, “WNL” is the clinical finding term that indicates that the Clinical Finding is “thyroid”. The term “WNL” is an indicator because it is a term denoting normal clinical status.

At line 212, in the string “The green phlegm”, “green” is the adjective that indicates that the Clinical Finding is “phlegm”. “Green” is an indicator because it is an adjective.

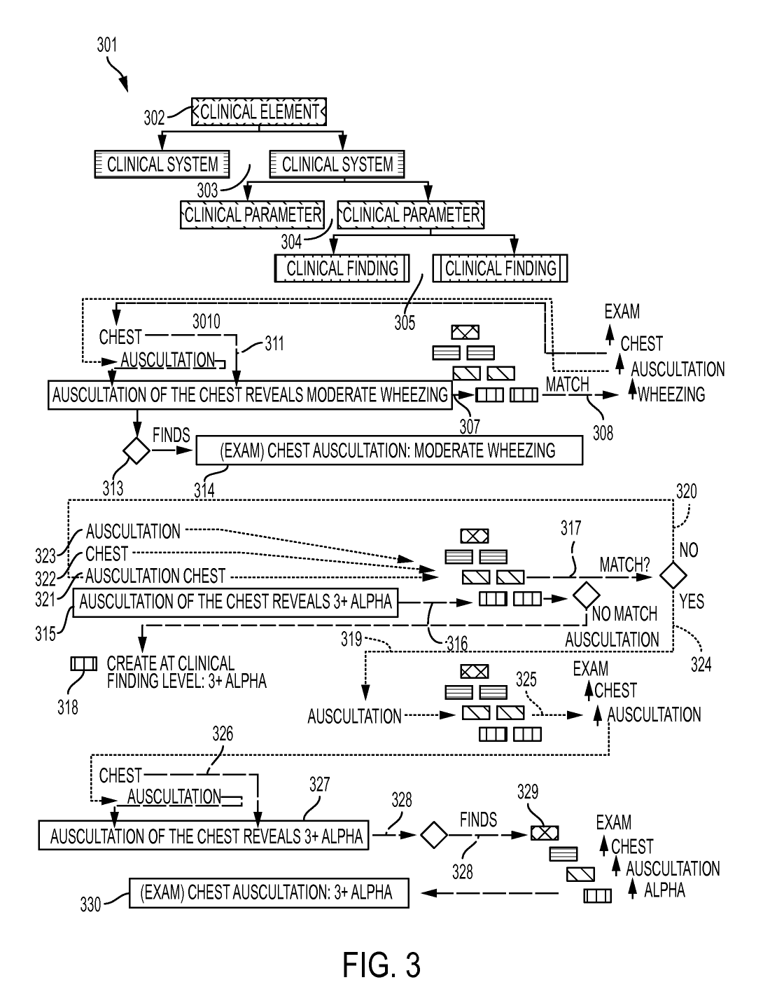

FIG. 3 illustrates the M-AI Clinical Hierarchy and its process of learning clinical terms and their proper level in the Clinical Hierarchy. M-AI's Clinical Hierarchy is a non-linear, branching tree hierarchy which consists of four branching levels 301. Clinical Element level 302 is the top level. Clinical System level 303 is the child level of Clinical Element. Clinical Parameter level 304 is the child level of Clinical System. Clinical Finding level 305 is the child level of Clinical Parameter.

In the narrative string “Auscultation of the chest reveals moderate wheezing” 306, the indicators “reveals” and “moderate” identify the clinical finding “wheezing”. At step 307, M-AI searches its Clinical Hierarchy at the level of Clinical Finding. At 308 the search yields a Clinical hierarchy match of “wheezing”. At 309, M-AI also returns the match's Clinical Parameter, Clinical System and Clinical Element levels of “auscultation”, “chest”, and Element. M-AI then searches the narrative string “Auscultation of the chest reveals moderate wheezing” for the narrative clinical terms that match both Clinical Hierarchy Clinical Parameter “auscultation” and Clinical Hierarchy Clinical System “chest” terms 310,311. At 313, the M-AI narrative string searches return matches for both Clinical Hierarchy level terms. Then, at 314, M-AI reformats the narrative string “Auscultation of the chest reveals moderate wheezing” with its Clinical Hierarchy formatted version “Chest auscultation: moderate wheezing”.

Because the Clinical System “Chest” is the child of the Clinical Hierarchy Clinical Element “Exam”, the formatted string “Auscultation of the chest reveals moderate wheezing” is programmatically processed as, and displayed in the electronic interface under “Exam”.

At 315, in another narrative string “Auscultation of the chest reveals 3+ alpha”, the indicators “reveals” and “3+” identify the clinical finding “alpha”. At 316, M-AI searches its Clinical Hierarchy at the level of Clinical Finding. At 317, the search yields no match. Because “alpha” is not found in the Clinical Hierarchy Clinical Finding, M-AI creates a new Clinical Hierarchy Clinical Finding term “alpha” at step 318. Also, because the newly created term “alpha” has no parent Clinical Hierarchy Clinical Parameter, M-AI serially searches its Clinical Hierarchy at the level of Clinical Parameter for “Auscultation of the chest” and permutations and combinations of the nouns in “Auscultation of the chest” until the search yields a match. See 319, 320, 321. M-AI's serial search of the Clinical Hierarchy Clinical Parameter yields a match, “auscultation”. See 324, 325.

M-AI uses the matched Clinical Hierarchy Clinical Parameter term, “auscultation” and its Clinical Hierarchy Clinical System term, “chest” for searches in the narrative string “Auscultation of the chest reveals 3+ alpha” for the narrative clinical terms that match both Clinical Hierarchy terms 326, 327. At 328, the M-AI narrative string searches return matches for both Clinical Hierarchy level terms. Because both Clinical Hierarchy terms are found in the narrative string, M-AI establishes the parent Clinical Hierarchy Clinical Parameter term “auscultation” as the parent of “alpha” and registers “alpha”. Chest's parent Clinical Element is Exam. At 329, M-AI registers the Clinical Hierarchy relationships as alpha, child of auscultation, child of “chest”, child of “Exam” accordingly. At 330, M-AI then reformats the narrative string “Auscultation of the chest reveals 3+ alpha” with its Clinical Hierarchy formatted version “Chest auscultation: 3+ alpha”.

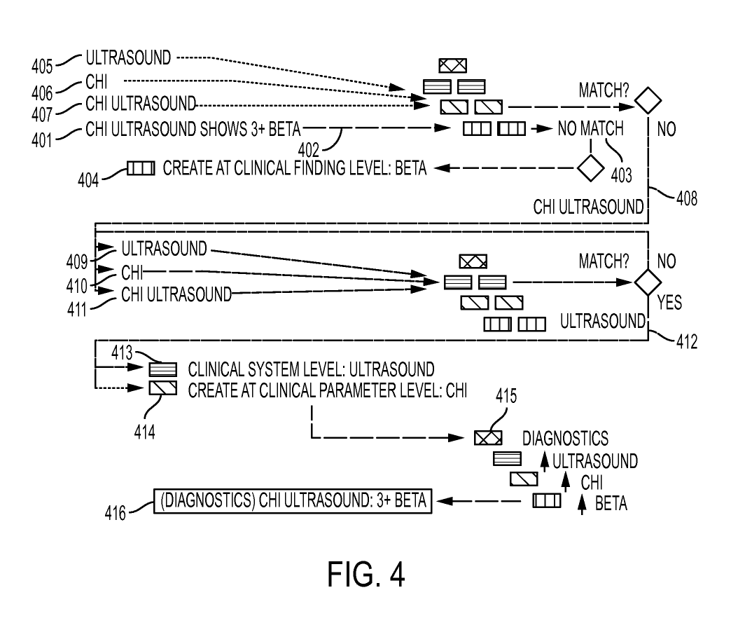

FIG. 4 illustrates M-AI's Clinical Hierarchy and its process of learning clinical terms and their proper level in the Clinical Hierarchy when narrative string searches return no match in the Clinical Hierarchy Clinical Parameter level.

At 401, in the narrative string “Chi ultrasound shows 3+ beta”, the indicators “shows” and “3+” identify the clinical finding “beta”. At 402, M-AI searches its Clinical Hierarchy at the level of Clinical Finding. The search yields no match, as can be seen at 403. Because “beta” is not found in the Clinical Hierarchy Clinical Finding, M-AI creates at 404 a new Clinical Hierarchy Clinical Finding term “beta”. Also, because the newly created term “beta” has no parent Clinical Hierarchy Clinical Parameter, M-AI serially searches its Clinical Hierarchy at the level of Clinical Parameter for “Chi ultrasound” and permutations and combinations of the nouns in “Chi ultrasound” until the search yields a match (see 405, 409, 407). At 408, no match is found.

Since no match is found, M-AI repeats the serial searches of the Clinical Hierarchy at the level of Clinical System for “Chi ultrasound” and permutations and combinations of the nouns in “Chi ultrasound” until the search yields a match. See 409, 410, 411. At 412, M-AI's serial search of the Clinical Hierarchy Clinical System yields a match, “ultrasound”. Because of the match, M-AI deploys the Clinical Hierarchy Clinical System term “ultrasound” 13. Removing “ultrasound” from “Chi ultrasound”, M-AI creates a new Clinical Hierarchy Clinical Parameter term “chi” at 414.

M-AI establishes the parent Clinical Hierarchy Clinical Parameter term “ultrasound” as the parent of “chi” and registers “beta”. Ultrasound's parent Clinical Element is Diagnostics. At 415, M-AI registers the Clinical Hierarchy relationships as beta, child of chi, child of “ultrasound”, child of “Diagnostics”. At 416, M-AI then reformats the narrative string “Chi ultrasound reveals 3+ beta” with its Clinical Hierarchy formatted version “Chi ultrasound: 3+ beta”.

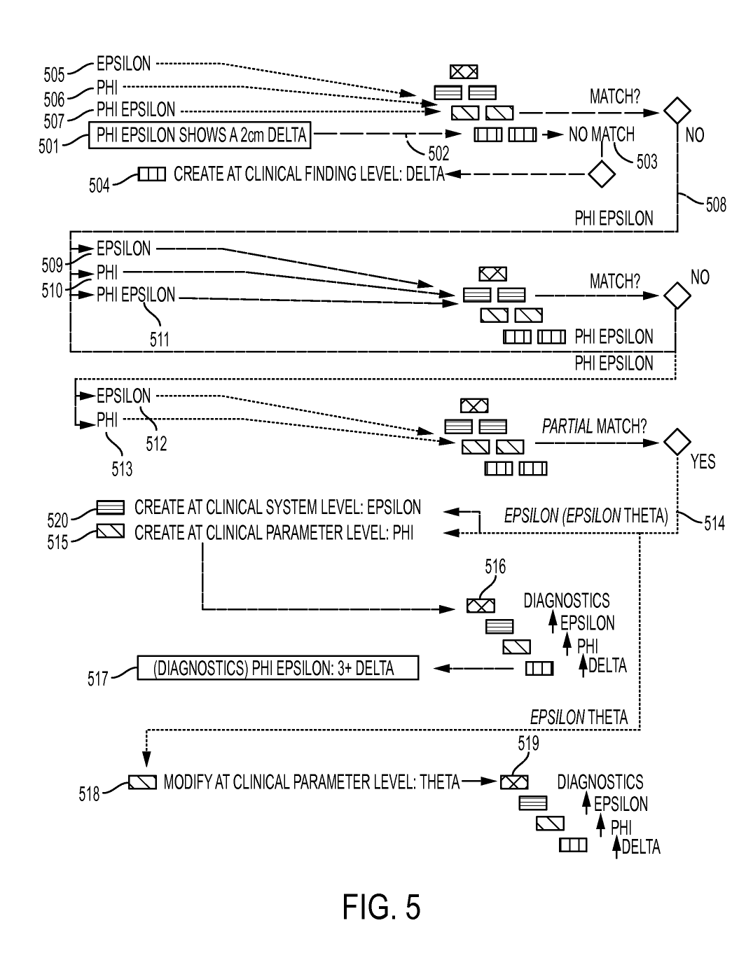

FIG. 5 illustrates the M-AI's Clinical Hierarchy and M-AI's process of learning clinical terms and their proper level in the Clinical Hierarchy when narrative string searches return no match in the Clinical Hierarchy Clinical Parameter and Clinical Hierarchy Clinical Parameter levels.

At 501, in the narrative string “Phi epsilon shows a 2 cm delta”, the indicators “shows” and “2 cm” identify the clinical finding “delta”. At 502, M-AI searches its Clinical Hierarchy at the level of Clinical Finding. The search yields no match, as can be seen at 503. Because “delta” is not found in the Clinical Hierarchy Clinical Finding, M-AI creates at 504 a new Clinical Hierarchy Clinical Finding term “delta”. Also, because the newly created term “beta” has no parent Clinical Hierarchy Clinical Parameter, M-AI serially searches its Clinical Hierarchy at the level of Clinical Parameter for “Phi epsilon” and permutations and combinations of the nouns in “Phi epsilon” until the search yields a match. See 505, 509, 507. No match is found, as can be seen at 508. Accordingly, M-AI repeats the serial searches at the Clinical Hierarchy at the level of Clinical System for Phi epsilon” and permutations and combinations of the nouns in “Phi epsilon” until the search yields a match. See 509, 510 and 511.

No match is found in the Clinical Hierarchy Clinical System level. At 512, 513, M-AI repeats serial searches at the Clinical Hierarchy Clinical Parameter for partial matches to “Phi epsilon”. The Clinical Parameter searches are done for Clinical Parameters whose top parent Clinical Element is “Diagnostics”, since the narrative string, “Phi epsilon shows a 2 cm delta” is in the “Diagnostics” section of the Electronic Clinical Chart Note. At 514, M-AI's serial search of the Clinical Hierarchy Clinical Parameter yields a partial match, “epsilon” with another Clinical Hierarchy Clinical Parameter “theta epsilon”. Because “epsilon” is common to “theta epsilon” and to “Phi epsilon”, M-AI considers epsilon to be a Clinical Hierarchy Clinical System term and creates at 520 a new Clinical System term “epsilon”. M-AI then creates at 515 a new Clinical Hierarchy Clinical Parameter term “phi”. At 516, M-AI registers the Clinical Hierarchy relationships as delta, child of phi, child of “epsilon”, child of “Diagnostics”. Then, at 517, M-AI reformats the narrative string “Phi epsilon shows a 2 cm delta” with its Clinical Hierarchy formatted version “Phi epsilon: 2 cm delta”.

Because “epsilon” has been created as a Clinical System term, M-AI modifies the Clinical Hierarchy Clinical Parameter term “theta epsilon” to “theta” at 518. M-AI modifies the Clinical Hierarchy relationships as phi, child of “epsilon”, child of “Diagnostics”.

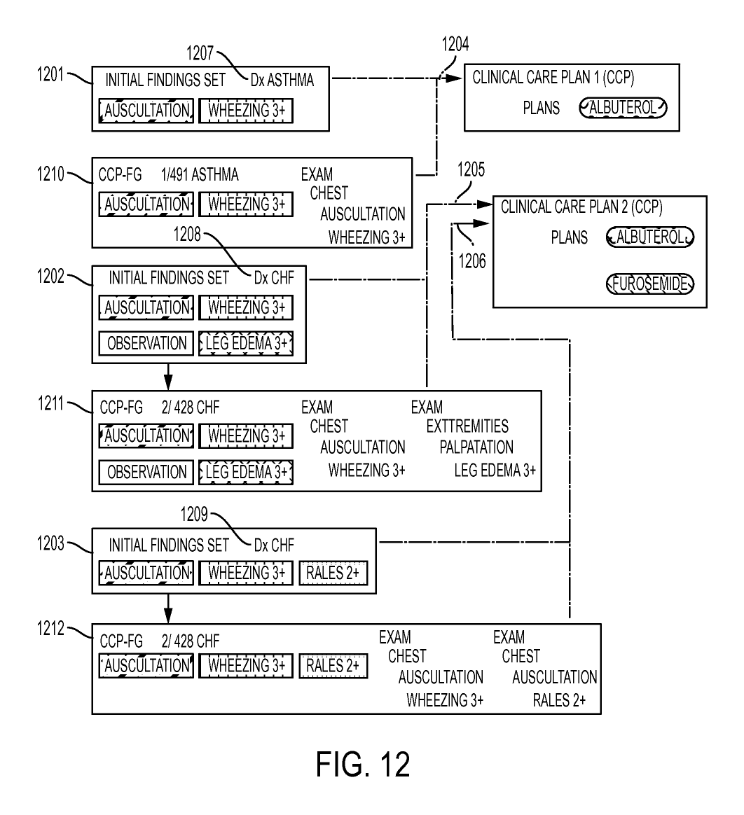

FIG. 12. illustrates an embodiment of an M-AI process of programmatically creating Clinical Care Plan-Finding Groups (CCP-FG)s for Clinical Care Plans. CCP-FGs are Initial Findings Sets 1201, 1202 and 1203. The Initial Findings Sets are the initial clinical findings of the Clinical Course Sets that have produced Clinical Care Plans 1204, 1205 and 1206. Each Initial Findings Set is organized by Clinical Hierarchy.

Each Initial Findings Set has a unique M-AI ID code number. Each Initial Findings Set has a diagnosis 1207, 1208, 1209, derived from the initial Electronic Clinical Chart Notes' in the Clinical Course Set.

At 1210, 1211, 1212, M-AI creates a Clinical Care Plan-Finding Group (CCP-FG) from each Initial Findings Set, which includes Initial Findings Set's clinical findings organized by M-AI's Clinical Hierarchy, the unique M-AI ID code number, the diagnosis and the diagnosis' ICD code. Each CCP-FG is linked to its Initial Findings Set Clinical Care Plan.

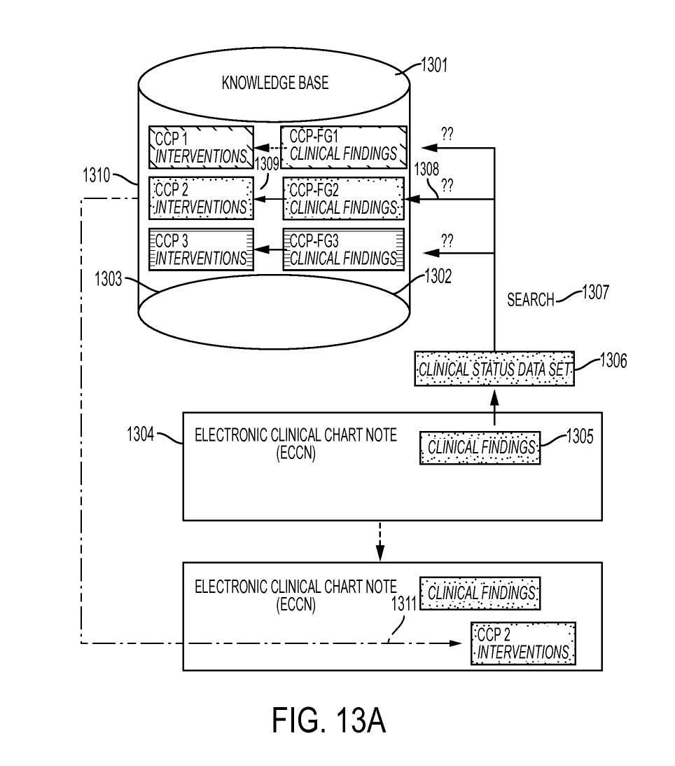

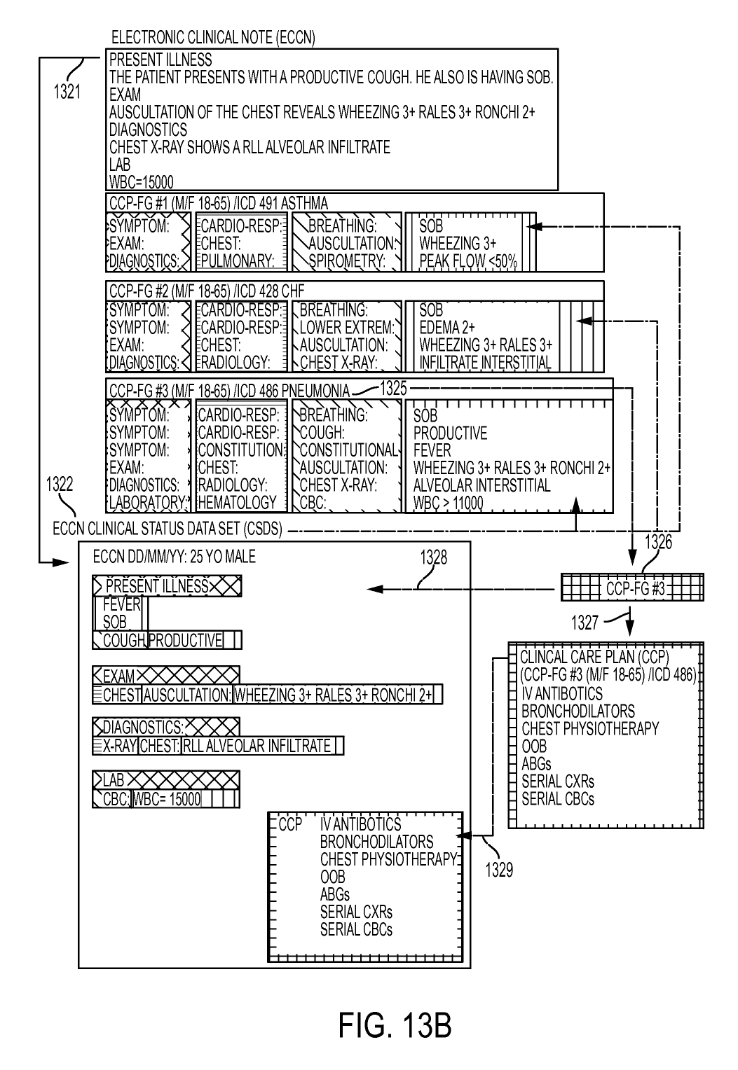

FIG. 13A illustrates the M-AI process of deploying its knowledge from its Knowledge Base in its goal of guiding patient care toward better outcomes by showing the relationships between its Clinical Care Plan-Findings Groups (CCP-FG)s, Clinical Care Plans (CCP)s and a patient's clinical findings as documented in an Electronic clinical Chart Note (ECCN).

M-AI's Knowledge Base 1301 comprises a data store having data reflecting Clinical Care Plan-Findings Groups (CCP-FGs) 1302 which are Clinical Hierarchy-formatted grouped clinical findings. The Electronic Clinical Chart Note 1304 has the clinical findings 1305 of a patient as entered by the clinician.

M-AI organizes each ECCN clinical finding by M-AI's Clinical Hierarchy and then groups the Clinical Hierarchy-formatted clinical findings into a Clinical Status Data Set 13066. M-AI uses the patient's Clinical Status Data Set for its Knowledge Base CCP-FG search 1307. At 1308, the search returns a match of CCP-FG 2, since CCP-FG 2 and the ECCN Clinical Status Data Set are identical.

At 1309, CCP-FG 2 is linked to Clinical Care Plan 2 (CCP 2). At 1310, 1311, M-AI then deploys CCP-FG 2's CCP 2 for use and display in the ECCN.

FIG. 13B illustrates the M-AI process of deploying its knowledge from its Knowledge Base in its goal of guiding patient care toward better outcomes by searching its Knowledge Base for Clinical Care Plan-Findings Group(s) that most closely match an individual's clinical status at a Point in Time (Time Point).

The individual's clinical status is documented in an Electronic Clinical Chart Note (ECCN), for a clinical patient-clinician encounter, 1321. M-AI parses the ECCN clinical data 1322 and organizes the clinical data by M-AI's Clinical Hierarchy into a Clinical Status Data Set (CSDS).

M-AI searches its Knowledge Base for the clinical findings that most closely match the clinical findings in the Clinical Status Data Set. The Knowledge Base search includes the individual's demographics.

At 1325, 1326, the Knowledge Base search returns Clinical Care Plan-Findings Group #3 (CCP-FG #3), since CCP-FG #3 is the closest match to the Clinical Status Data Set 6. M-AI deploys CCP-FG #3's Clinical Care Plan (CCP) 7. At 1328 and 1329, M-AI deploys CCP-FG #3 and CCP-FG #3's Clinical Care Plan (CCP) for user guidance/review and M-AI programmatic use.

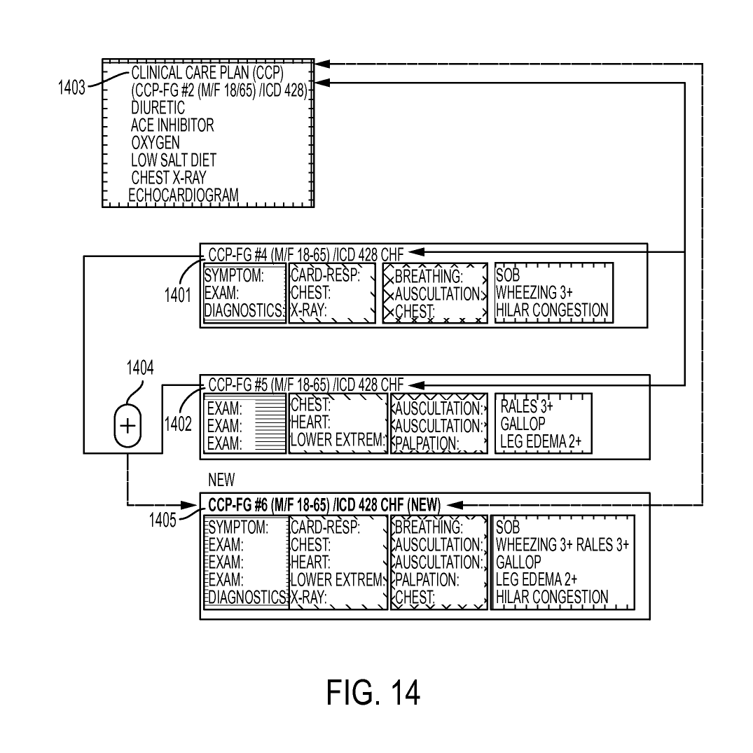

FIG. 14. illustrates the M-AI process of using inferential logic to combine and create new Clinical Care Plans-Findings Groups (CCP-FG)s using CCP-FGs from its Knowledge Base. M-AI compares CCP-FGs that share the same Clinical Care Plan. When CCP-FGs share the same CCP and the CCP-FGs have the same demographics and diagnoses, M-AI creates a new CCP-FG, combining the clinical findings of each CCP-FG.

At 1401, 1402, 1403, M-AI compares two CCP-FGs, CCP-FG #4 and CCP-FG#5, and learns that they share the same Clinical Care Plan (CCP-FG #2 (M/F 18-65)/ICD 428).

By inferential logic, M-AI concludes at 1404, 1405 that, since both share the same Clinical Care Plan and have the same demographics and diagnosis, the clinical findings of each CCP-FG can be collated to create a new CCP-FG, CCP-FG#6.

M-AI can assign new CCP-FG #6 with the ICD code and demographics of both CCP-FG #4 and CCP-FG#5.

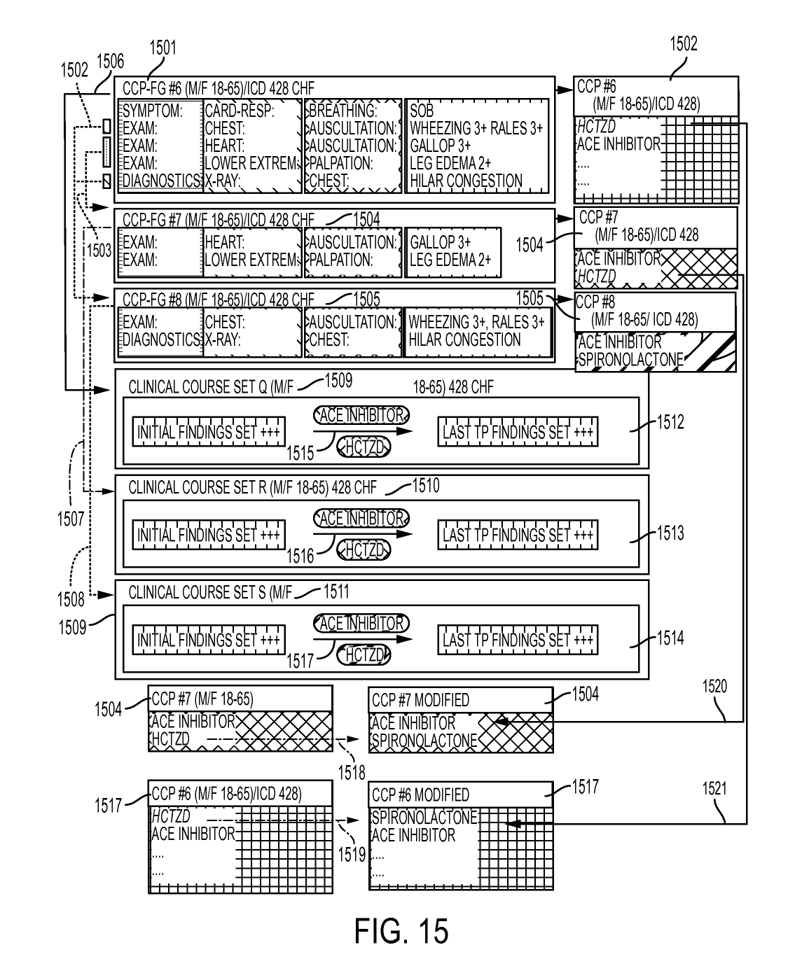

FIG. 15. illustrates the M-AI process of using deductive and inferential logic to modify Clinical Care Plans in its Knowledge Base.

At 1501, 1502, 1503, M-AI performs serial searches of permutations and combinations of subsets of CCP-FG #6's clinical findings. At 1504, 1505, the searches return CCP-FG #7 and CCP-FG #8.

At 1506, 1507, 1508, M-AI then searches its Patient Databases for Clinical Course Sets (CCS)s that have Initial Findings Sets matching the Initial Findings Sets for CCP-FG #6 CCP-FG #7 and CCP-FG #8. At 1509, 1510, 1511, the searches return CCS Q for CCP-FG #6 CCS R for CCP-FG #7 and CCS s for CCP-FG #8.

At 1512 and 1513, M-AI notes that there has been the same degree of improvement the Initial Clinical Findings Sets' Clinical Findings for CCS Q and CCS R from the Initial Time Point Set to the Last Time Point Set, from +++ to ++. At 1514, M-AI notes that CCS S shows the best improvement, from +++ to +.

At 1515, 1516, 1517, M-AI notes that the CCS S's Intervention set differs from the Intervention Sets of CCS Q and CCS R, showing the intervention “Spironolactone” instead of Hctzd (hydrochlorthiazide). M-AI deduces that Spironolactone is a better intervention than Hctzd (hydrochlorthiazide).

M-AI infers at 1518, 1519 that, since all three CCSs have the same diagnosis, CHF, and that Spironolactone is a better intervention than hydrochlorthiazide, that Spironolactone should replace Hctzd (hydrochlorthiazide) in the Clinical Care Plans (CCP)s of CCP-FG #6 and CCP-FG #7. At 1519,1520, 1521, M-AI replaces Hctzd (hydrochlorthiazide) in the Clinical Care Plans (CCP)s of CCP-FG #6 and CCP-FG #7.

M-AI tracks CCS Q and CCS R to confirm that the CCP modifications made are reflected in better outcomes for the CCSs.

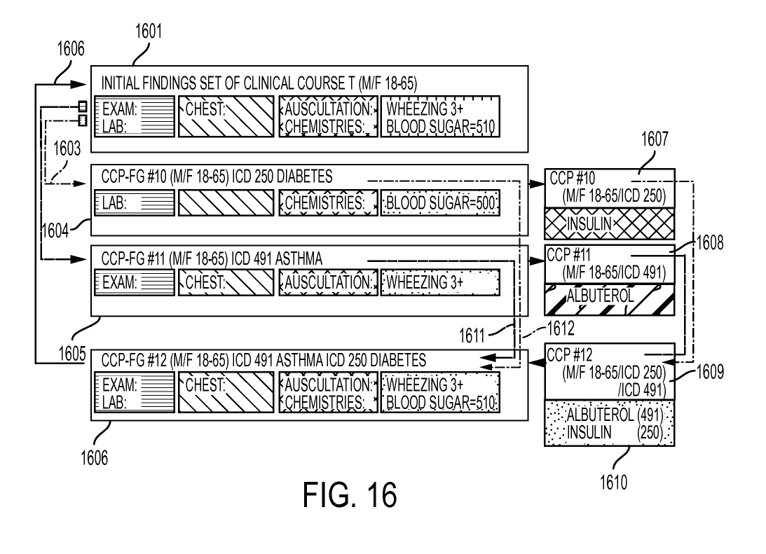

FIG. 16. illustrates the M-AI process of creating new Clinical Care Plans in its Knowledge Base, by combining existing Clinical Care Plans and linking Clinical Care Plans' Plans to diagnoses.

At 1601, 1602, 1603, M-AI performs serial searches of permutations and combinations of the Initial Findings Set of Clinical Course Set T. At 1604, 1605, the searches return CCP-FG #10 (250 Diabetes) and CCP-FG #11 (491 Asthma).

At 1606, M-AI creates CCP-FG #12 for Clinical Course Set T. Because CCP-FG #10 and CCP-FG #11 together comprise the clinical findings of the Initial Findings Set of Clinical Course Set T, M-AI creates a Clinical Care Plan (CCP) by combining CCP #10 and CCP 11 to make CCP 12 for CCP-FG #12. See 1607, 1608, 1609. At 1611, 1612, M-AI links CCP 12's Plans to the diagnoses from the derived from CCPs. At 1611, 1612, M-AI assigns CCP-FG #12 the diagnoses derived from CCP 10 and CCP.

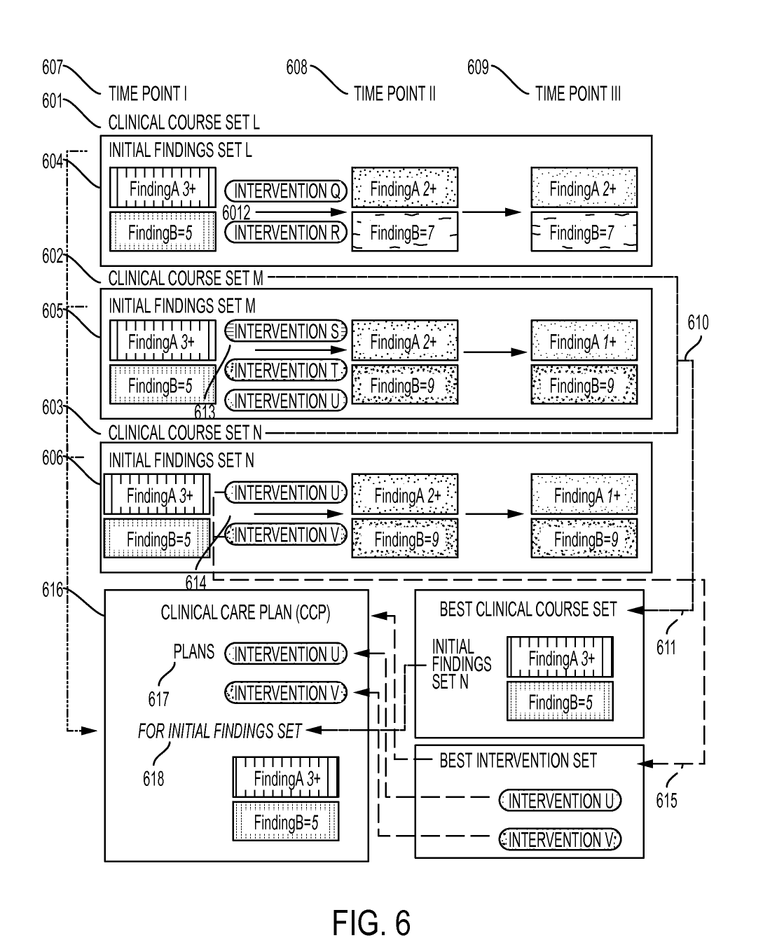

FIG. 6 illustrates the M-AI process of programmatically deducing and learning the clinical interventions that produce better patient clinical outcomes to create Clinical Care Plans (CCP)s.

Three Clinical Course Sets (CCS)s are represented, CCS L at 601, CCS M at 602, and CCS N at 603. Each CCS is a compilation of similar patient clinical courses found in M-AI's Patient Databases.

Each CCS has its own Initial Findings Set 604, 605, 606, consisting of its clinical findings, in M-AI's Clinical Hierarchy format, at the first point in time (Time Point), Time Point I, in its clinical course. Because all three Clinical Course Sets have the same Initial Findings Sets at the initial Time Point, Time Point I, M-AI programmatically compares these three CCSs.

Three points in time 607, 608, 609 for the Clinical Course Sets (Time Points) are represented. The three points may be different for each Clinical Course Set and/or different for each patient in each Clinical Course Set. The Time Points may be Electronic Clinical chart Note (ECCN) times and dates, but may also be other M-AI or user selected dates and times.

Clinical findings may be ECCN Clinical Findings and/or other patient clinical data recently most appropriately recent to each Time Point, such as biometric inputs, lab test reports and diagnostic test reports.

M-AI programmatically compares FindingA and FindingB of the Initial Findings Set serially across each of the three Time Points for each Clinical Course Set. In this representation, FindingA is described in terms of its severity. FindingB is described as a numerical value with FindingB's normal numerical value being 10. M-AI compares the clinical findings at the Time Points and deduces that that all three Initial Findings Sets show improvements of varying degree, all showing return towards normal. M-AI programmatically deduces that CCS M and CCS N show the same degree of improvement and each shows more improvement than CCS L.

At 610, M-AI programmatically notes that that CCS M and CCS N are the same Clinical Course Set. At 611, M-AI programmatically deduces and learns that that CCS M and CCS N are identical and are the Best Clinical Course Set.

Interventions are the interventions performed between, or at, the Time Points 612, 613, 614. An intervention can be any kind of clinical action performed for, or to, a patient. M-AI then programmatically compares the interventions in CCS M and CCS N. See 613, 614. At 615, M-AI deduces that the interventions in CCS N are fewer than in CCS M and therefore are the better interventions, since they are associated with the same degree of improvement as the interventions in CCS M. M-AI creates an Intervention Set comprised of Intervention U and Intervention V. M-AI may additionally use intervention attributes, such as invasiveness, potential adverse effects and cost in deducing better Intervention Sets.

At 615, M-AI programmatically deduces and learns that the best interventions for the three Clinical Course Sets, all having the same Initial Findings Set, are CCS N's interventions and are the Best Intervention Set.

M-AI creates a Clinical Care Plan (CCP) 616 which consists of the Best Intervention Set. The Clinical Care Plan consists of Plans 617 which are the best Intervention Set's interventions comprised of Intervention U and Intervention V. The Clinical Care Plan is created for the Initial Findings Set FindingA 3+ and FindingB 5, common to all three Initial Findings Sets. See 618. M-AI stores the Clinical Care Plan in its Knowledge Base.

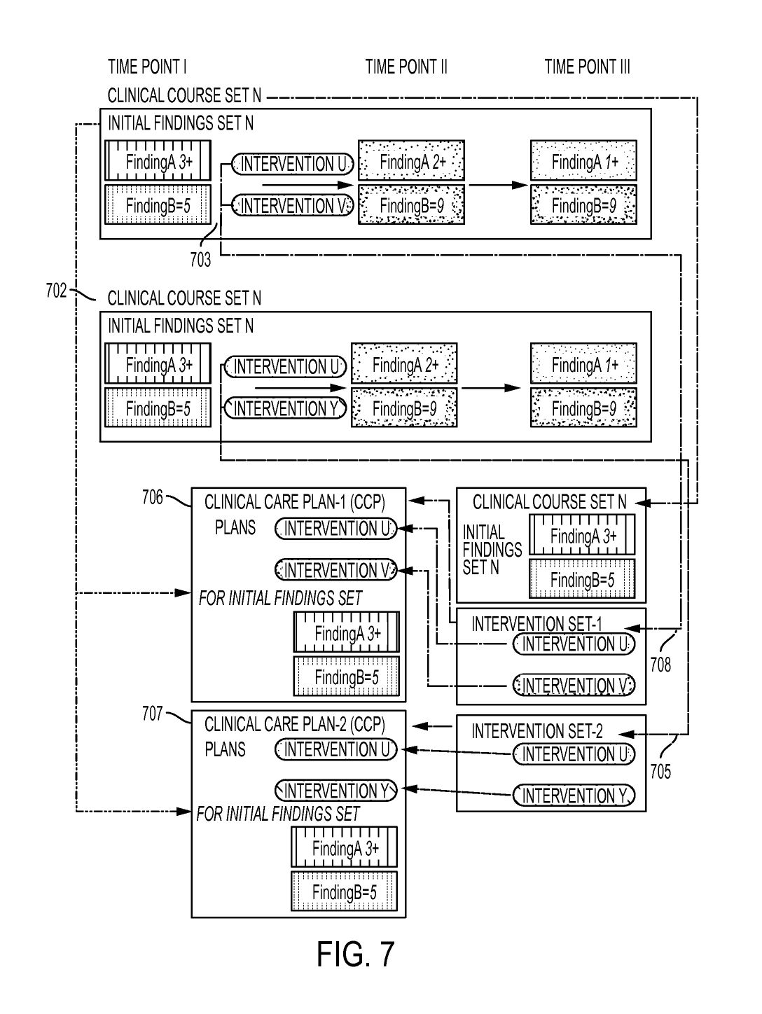

FIG. 7. illustrates the M-AI process of programmatically creating more than one Clinical Care Plans (CCP) for a Best Clinical course Set (CCS). CCS N, with its Initial Findings Set, is represented twice. See 701, 702. Each CCS N representation has different interventions 703, 704. Since CCS N has sets of different interventions, at 705, 708 M-AI creates two Intervention Sets for CCS N. At 706, 707 M-AI creates two Clinical Care Plans (CCP)s, Clinical Care Plans-1 and Clinical Care Plans-2. CCP-1 consists of Intervention Set-1. CCP-2 consists of Intervention Set-2. M-AI stores the Clinical Care Plan in its Knowledge Base.

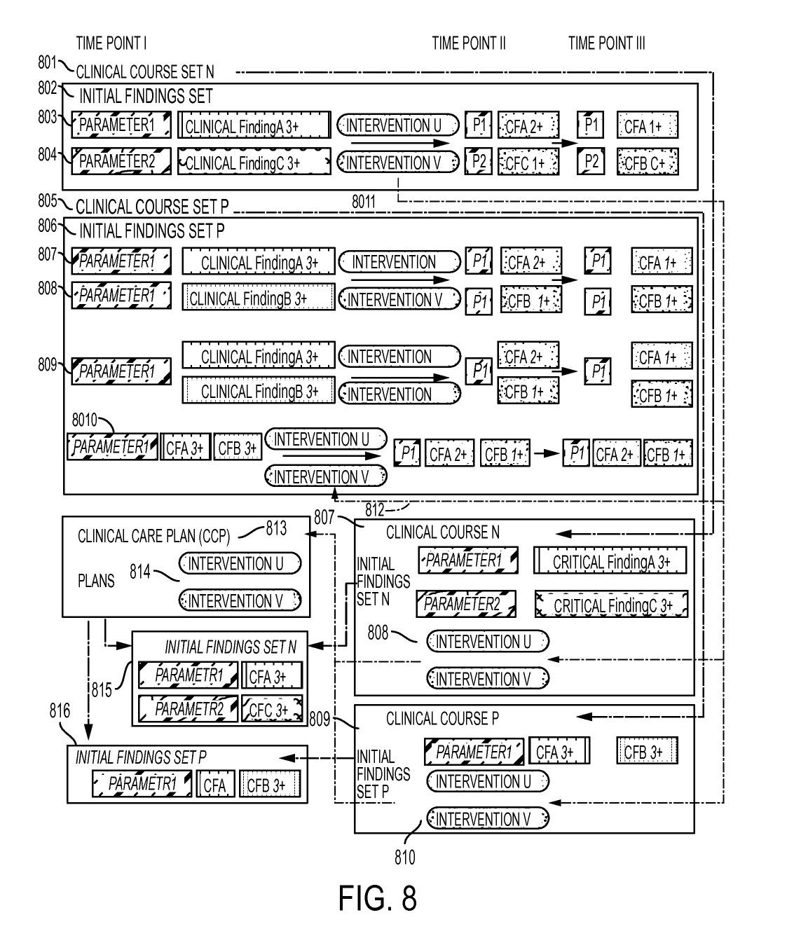

FIG. 8. illustrates the M-AI process of programmatically creating the same Clinical Care Plan (CCP) for more than one Best Clinical Course Set (CCS). FIG. 8. also illustrates two Best Clinical Course Set's with two different Clinical Hierarchy child-parent relationships.

Clinical Course Set N shows an Initial Findings Set with two Clinical Hierarchy clinical findings. See 801, 802. Each Clinical Finding has a different parent Clinical Parameter, PARAMETER1 at 803 and PARAMETER2 at 804. Clinical Course Set P shows an Initial Findings Set with two Clinical Hierarchy clinical findings. See 805, 806. At 808, it can be seen that each Clinical Finding has the same parent Clinical Parameter, PARAMETER1.

Clinical Parameter PARAMETER1 with its two clinical findings is also represented in two additional ways. PARAMETER1 is shown once with its two clinical findings, each Clinical finding on its own line. See 809. PARAMETER1 is shown once with its two clinical findings, the two Clinical finding concatenated on the same line with PARAMETER1. See 810. Clinical Course Set P's three different Clinical Hierarchy representations are programmatically processed the same way by M-AI.

Both CCS N and CCS P have the same Intervention Sets, Intervention U and Intervention V. See 811, 812. Therefore, at 813, 814, M-AI creates the same Clinical Care Plan (CCP) for both Best Clinical Course Sets, consisting of the Intervention Set common to both CCSs. Therefore the single CCP has two CCSs, each with its own Initial Findings Set 815, 816.

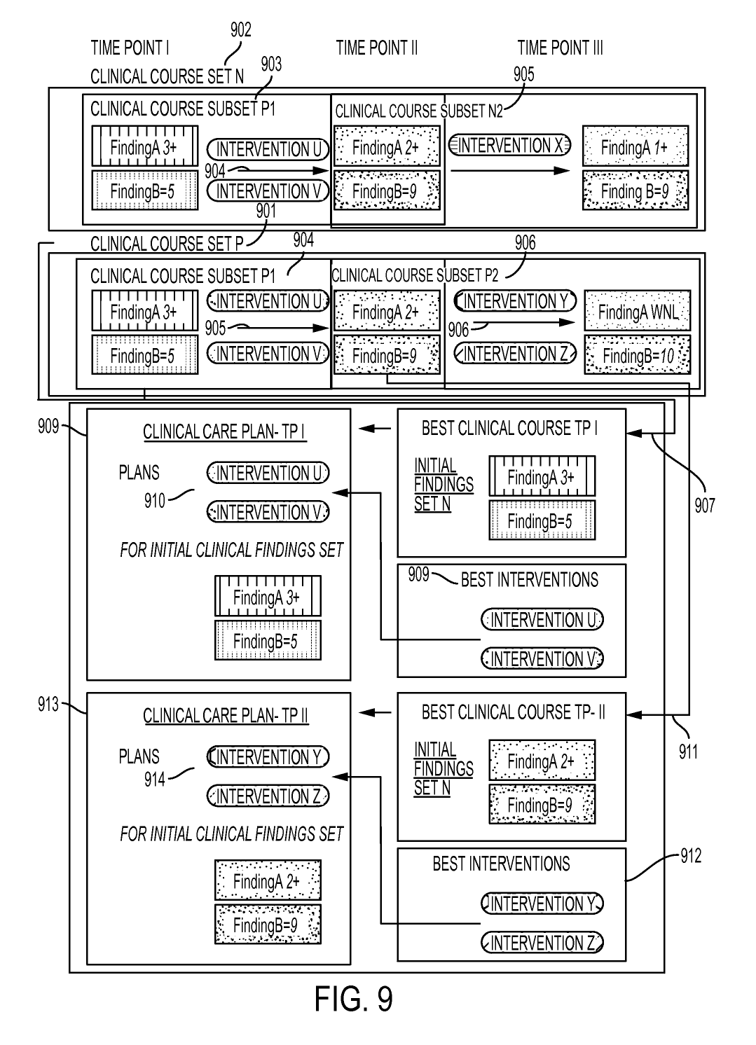

FIG. 9. illustrates the M-AI process of programmatically creating multiple Clinical Care Plans (CCP)s for multiple Time Points for a Clinical Course Set (CCS).

Clinical Course Set P at 901 is a best clinical course. Clinical Course Set N shares the same Initial Findings Set at Time Point I with CCS P. See 902, 903 and 904. CCS N and CCS P also shares the same Findings Set at Time Point II. See 905, 906. Because CCS N and CCS P share the same Findings Set at Time Point II, M-AI creates a Clinical Course subset from Time Point II to Time Point III for both CCS N and CCS P, with the Findings Set at Time Point II becoming the Initial Findings Sets for both CCS N and CCS P.

M-AI also creates a Clinical Course subset for both CCS N and CCS P, from Time Point I to Time Point II, which are identical to each other since they share the same Findings Sets at both Time Points. See 903, 904.

Since Clinical Course Set P is a Best CCS, M-AI creates a Clinical Care Plan, Clinical Care Plan-TPI, for Clinical Course Subset P1 at Time Point I consisting of the Intervention Set between Time Points I and II. See 907, 908, 909, 910. Clinical Care Plan-TPI is also the Clinical Care Plan for CCS N at Time Point I, even though CCS N is not a Best Clinical Course Set, since CCS N shares the same Clinical Course subset with Best CCS P, Clinical Course Subset P1. See 903, 904.

M-AI determines Clinical Course Subset P2 has a better outcome Clinical Course Subset N2. M-AI creates a Clinical Care Plan 913, Clinical Care Plan-TPII, at Time Point II for Clinical Course Subset P2. The CCP Plans are the Intervention Set between Time Point II and Time Point III. See 914.

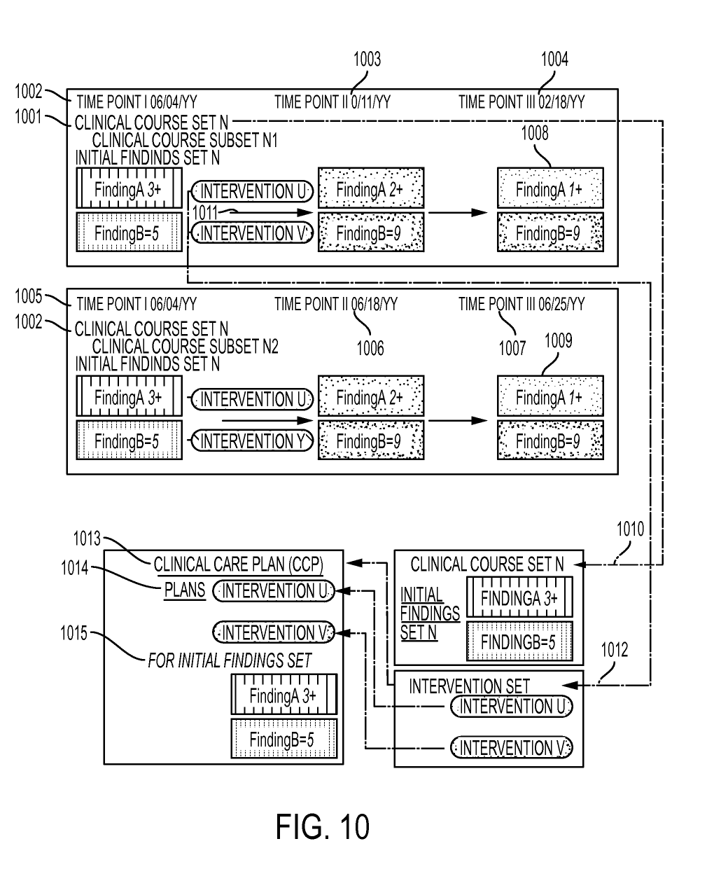

FIG. 10. illustrates the M-AI process of programmatically deducing and learning the clinical interventions that produce better patient clinical outcomes to create Clinical Care Plans (CCP)s, by determining the interval of improvement in clinical outcomes.

At 1001, 1002, M-AI programmatically examines Clinical Course Set N (CCS) N. M-AI determines that subsets of CCS N have different CCS intervals of time between Time Points 1202, 1203, 1204, 1205, 1206, and 1207. M-AI creates two subsets of CCS N, CCS, Clinical Course Subset N1 and Clinical Course Subset N2.

At 1010, M-AI determines that Clinical Course Subset N1 has a shorter course length then Clinical Course Subset N2 and therefore is the best Clinical Course Subset. M-AI programmatically deduces and learns that the best Intervention Set for Clinical Course Set N consist of Intervention U and Intervention V since they produce a shortest clinical course. See 1011, 1012. M-AI creates a Clinical Care Plan with Plans consisting of the Intervention Set, Intervention U and Intervention V. See 1013, 1014. The CCP is for the CCS N's Initial Findings Set. See 1015.

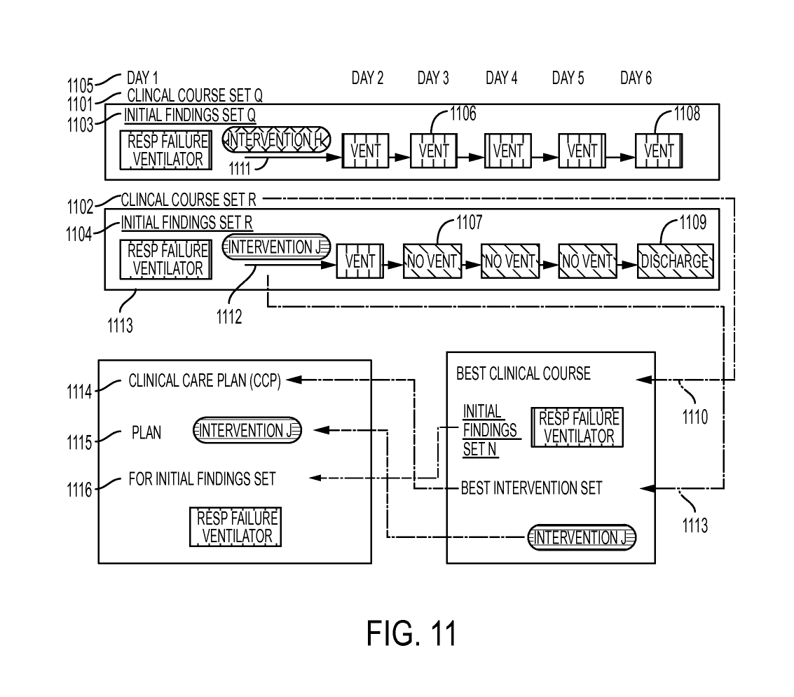

FIG. 11. illustrates the M-AI process of programmatically deducing and learning the clinical interventions that produce better patient clinical outcomes for inpatient hospital clinical courses.

M-AI compares two Clinical Course Sets (CCS) of patients admitted to the hospital in acute respiratory failure requiring a ventilator to breath, CCS Q at 1101 and CCS R at 1102. CCS Q and CCS R have the same Initial Findings Set 1103, 1104, consisting of “Resp Failure” and “Ventilator”. The Time Points in the CCSs are each day 1105 of the hospital stay.

M-AI compares the two Clinical Course Sets over six days (Time Points) and notes that on Day 3, that CCS R shows no ventilator support, while CCS Q shows continued ventilator support over the entire six-day hospital course. See 1106, 1107. M-AI also notes that CCS R hospital stay is shorter than CCS Q, since CCS R shows discharge on Day 6, while CCS Q shows continued inpatient stay. See 1108, 1109. At 1110, M-AI deduces that CCS R is the Best Clinical Course Set.

At 1111, 1112, M-AI then programmatically compares the interventions in CCS Q and CCS R. M-AI deduces and learns that CCS R's Intervention Set, consisting of Intervention J, is the best Intervention Set since it has produced the best clinical outcome: ventilator support no longer present on Day 3 and discharge from the hospital on Day 6. See 1113.

At 1113, 1114, 1115, M-AI creates a Clinical Care Plan consisting of Plans consisting of the best Intervention Set. As can be seen at 1116, the Clinical Care Plan is created for the Initial Findings Set “Resp Failure” and “Ventilator”.

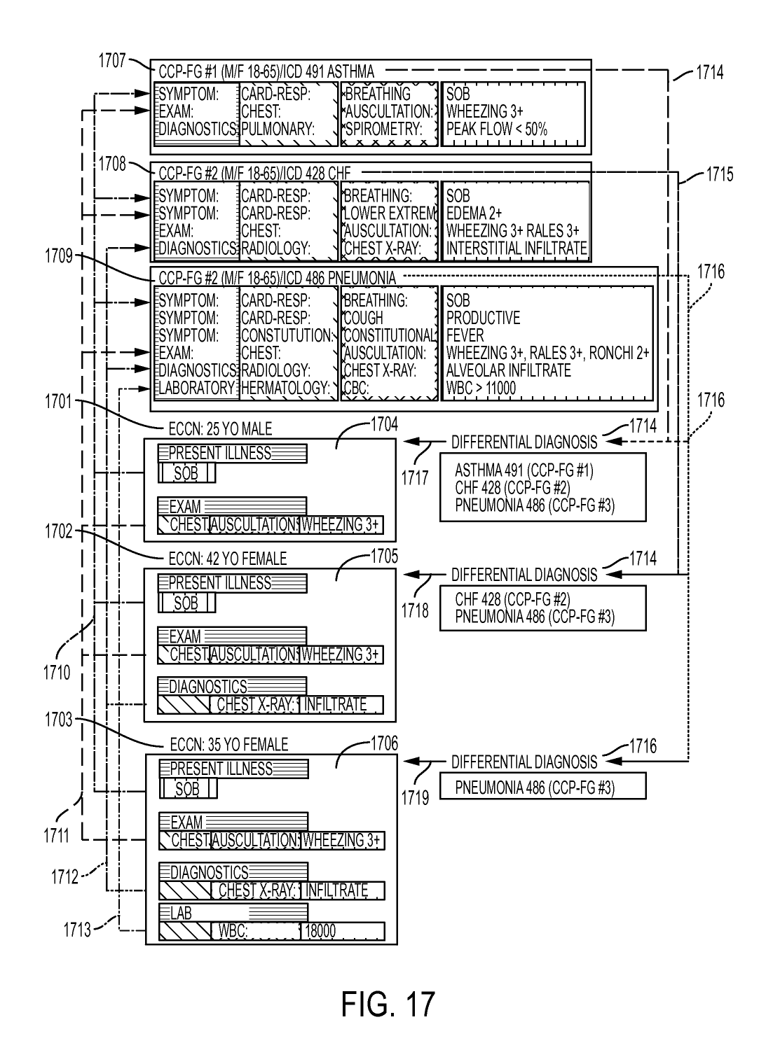

FIG. 17 illustrates the M-AI process of deploying the knowledge from M-AI's Knowledge Base by guiding users in formulating clinical diagnoses for patients at a point in time (Time Point), as a function of a patient's clinical status at a Time Point.

The Electronic Clinical Chart Notes (ECCN) for three different patients are displayed, each with a different clinical presentation 1701, 1702, 1703. M-AI creates a Clinical Status Data Set (CSDS) 1704, 1705, 1706 from the clinical information in each ECCN, which has been organized by M-AI's Clinical Hierarchy. Three CCP-FG's 1707, 1708, 1709 in a Knowledge Base are displayed. At 1710, 1711, 1712, M-AI searches each CCP-FG for each Clinical Finding in each Clinical Status Data Set. The Aqua Blue search lines and text show searches and matches for “SOB” (shortness of breath) at 1710. The Red search lines and text show searches and matches for “wheezing 3+” at 1711. The Blue search lines and text show searches and matches for “Chest x-ray: Infiltrate” at 1712. The Violet search lines and text show searches and matches for “WBC 18000” at 1713.

The ECCN for the 25 yo male shows three CCP-FG match returns for the clinical findings in its Clinical Status Data Set, CCP-FG #1 491 Asthma, CCP-FG #2 428 CHF and CCP-FG #3 486 Pneumonia. See 1701, 1714, 1715, 1716. The ECCN for the 42 yo female shows two CCP-FG match returns for the clinical findings in its Clinical Status Data Set, CCP-FG #2 428 CHF and CCP-FG #3 486 Pneumonia. See 1702, 1715, 1716. The ECCN for the 35 yo female shows a single CCP-FG match return for the clinical findings in its Clinical Status Data Set, CCP-FG #3 486 Pneumonia. See 1703, 1716.

At 1717, 1718, 1719, M-AI presents the Differential Diagnosis Lists to the user. The differential diagnosis list can consist of M-AI internal code numbers or clinical diagnoses.

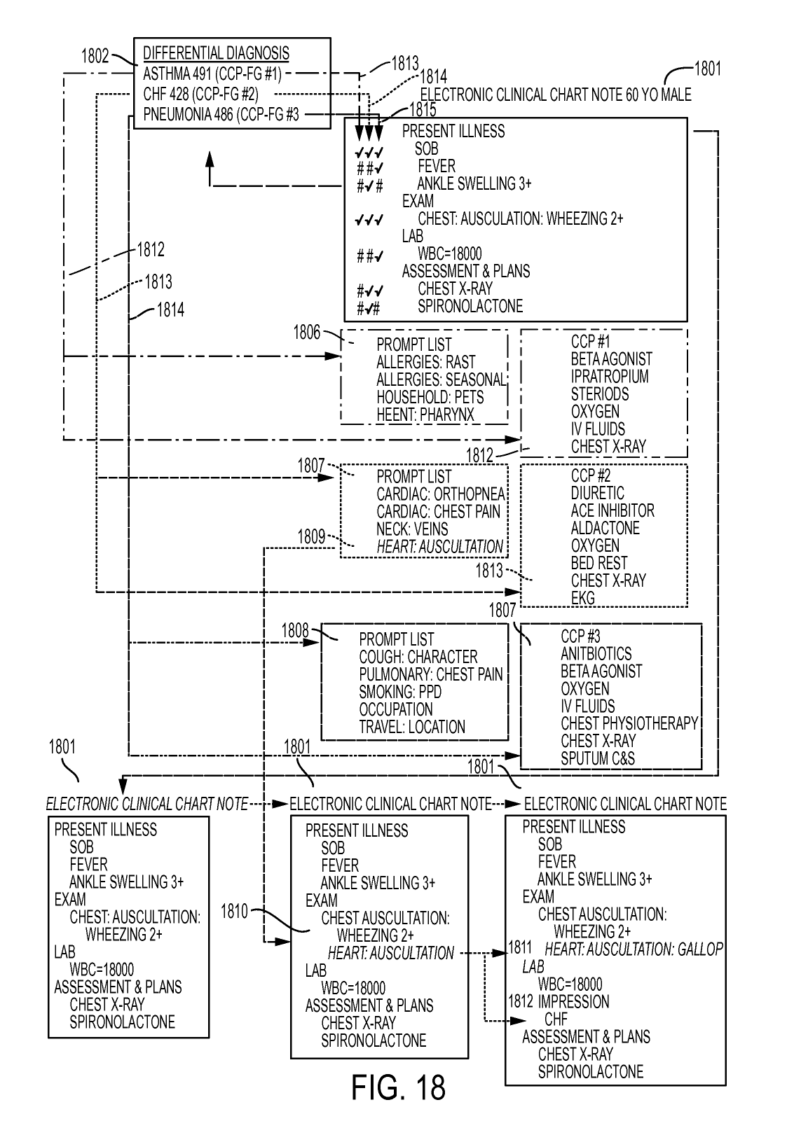

FIG. 18. illustrates the M-AI process of deploying the knowledge from M-AI's Knowledge Base to guide clinician evaluation and better understanding of a patient's clinical presentation when writing or reviewing Electronic Clinical Chart Notes (ECCN). M-AI programmatically reviews ECCN clinical findings when a diagnosis is selected in a differential diagnosis list or in the “Impressions” section of the ECCN. The differential diagnosis list can consist of M-AI internal code numbers or clinical diagnoses.

M-AI parses ECCN clinical information narrative text into clinical findings and organizes the clinical findings by M-AI's Clinical Hierarchy into a Clinical Status Data Set. M-AI searches its Knowledge Base for the CCP-FGs that most closely match the Clinical Status Data Set to display differential diagnoses. See 1801, 1802. M-AI returns CCP-FGs with three diagnoses, Asthma, CHF and Pneumonia.

M-AI performs several actions when one of the diagnoses is selected.

At 1803, 1804, 1805, selection of a diagnosis enables M-AI to annotate each Clinical Finding with a character denoting whether or not the Clinical Finding supports the selected diagnosis. “✓” character denotes support, a “#” denotes lack of support. The lefthand column 1803 shows annotation when Asthma is selected. The second column 1804 shows annotation when CHF is selected. The third column 1805 shows annotation when Pneumonia is selected.

Selection of a diagnosis enables M-AI to display a Prompt list, prompting the user for entry of clinical findings needed to support the selected diagnosis. See 1806, 1807, 1808. User selection of an item in the Prompt list causes M-AI to enter the selected Prompt list item (awaiting user response) in the ECCN. User selection of “Heart: auscultation” displays “Heart: auscultation” in the ECCN, awaiting user entry of the clinical finding of the heart auscultation. See 1809, 1810. At 1811, the user responds to the Prompt by entering “Gallop” in the ECCN line showing “Heart: auscultation”. User entry of “Gallop” reduces the differential diagnosis list to a single diagnosis, CHF. The user enters CHF as the diagnosis in the ECCN Impression section.

At 1812, 1813, 1814, selection of a diagnosis enables M-AI to display a Clinical Care Plan, consisting of Plans in the CCP for the selected diagnosis. User selection of a CCP Plan item enters the Plan in the “Assessment and Plans” section of the ECCN”.

Selection of a diagnosis enables M-AI to annotate each Plan in the “Assessment and Plans” section of the ECCN with a character denoting whether or not the Plan medically appropriate for the selected diagnosis. “✓” character denotes medical appropriateness, a “#” denotes medical inappropriateness.

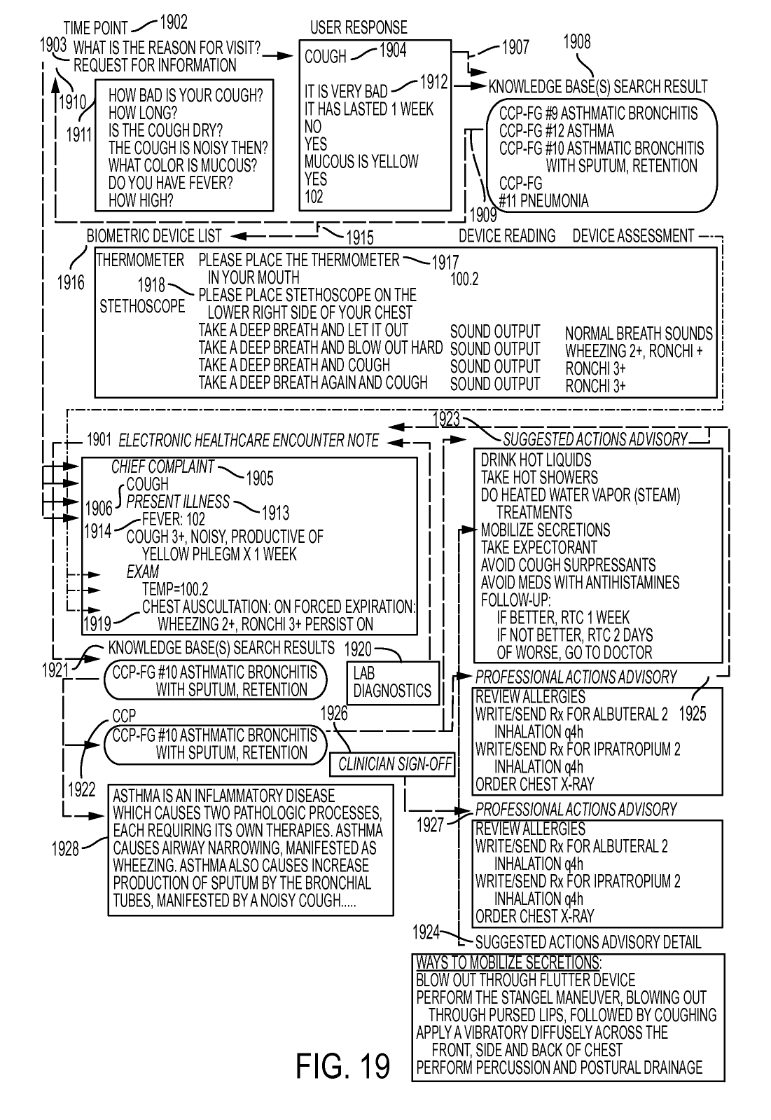

FIG. 19. illustrates the M-AI process of programmatically evaluating the clinical status of a patient and implementing the Clinical Care Plans that are returned as a result of the clinical evaluation during an Electronic Healthcare Encounter (EHE).

At 1901, M-AI creates an Electronic Health Care Encounter Note (EHEN) for the date and time (Time Point) 1902. At 1903, M-AI initially prompts the patient-user for the patient-user's reason for the EHE, which may be a such reasons as a health problem, symptom or illness. M-AI parses the patient-user narrative response for clinical finding(s) and organizes the clinical finding(s) by its Clinical Hierarchy. M-AI enters the patient-user Clinical Hierarchy formatted response in the EHEN under Chief Complaint. See 1904, 1905, 1906. M-AI initiates a Clinical Data Set of the Clinical Hierarchy formatted response.

At 1907, M-AI searches its Knowledge Base for CCP-FG matches to the Clinical Data Set. CCP-FG matches to the Clinical Data Set are returned at 1908. M-AI programmatically deploys the returned CCP-FG matches to create an Request For Information (RFI) list of items for display to the patient-user 1909, 1910. M-AI may present each RFI item in narrative format.

The patient-user selects each RFI item and enters a response 1911, 1912. M-AI enters the patient-user the Clinical Hierarchy-formatted RFI and response in the EHEN in the Present Illness section. See 1913, 1914. M-AI adds the Clinical Hierarchy formatted RFI and response to the Clinical Data Set. M-AI repeats CCP-FG searches with the updated Clinical Data Set and modifies and refreshes the RFI list as a function of the CCP-FGs returned.

M-AI continues the CCP-FG search, RFI modification and refresh cycle until the number of CCP-FG matches are no longer decreasing.

M-AI deploys the CCP-FGs returned from its final Knowledge Base CCP-FG search to determine the required examination of the patient 1915. M-AI then determines the required biometric devices to perform the examination 16. M-AI displays the required biometric devices in list for the patient-user at 1916. At 1917, 1918, M-AI displays next to each biometric device the directions on how to manipulate the device for the patient-user. M-AI deploys the biometric device outputs for entries in the EHEN Exam section. The entries may be actual biometric device readings or programmatic assessments of the readings. See 1919, 1920. M-AI adds each biometric device reading or assessment to the Clinical Data Set.

At 1920, M-AI searches its Knowledge Base for CCP-FG matches to the Clinical Data Set. M-AI may modify the displayed RFI list, Biometric Device List as well as biometric manipulation directions as a function of the returned CCP-FG matches. If modifications have been made, M-AI awaits user responses. M-AI repeats this cycle until the number of CCP-FG matches are no longer decreasing.

M-AI downloads the patient's lab data and diagnostic test results most appropriately recent to the Time Point. M-AI parses the downloads for clinical findings and organizes the clinical findings by its Clinical Hierarchy. M-AI enters the Clinical Hierarchy formatted lab data and diagnostic test results in the EHEN. M-AI enters the Clinical Hierarchy formatted lab data and diagnostic test results to Clinical Data Set.

M-AI searches its Knowledge Base for CCP-FG matches to the Clinical Data Set. M-AI may modify the displayed RFI list, Biometric Device List as well as biometric manipulation directions as a function of the returned CCP-FG matches. If modifications have been made, M-AI awaits user responses. M-AI repeats this cycle until the number of CCP-FG matches are no longer decreasing.

If M-AI's final Knowledge Base search returns at 1921 a single CCP-FG, M-AI, M-AI can programmatically implement healthcare actions for the patient. M-AI programmatically executes the CCP-FG's Clinical Care Plan for healthcare implementation for the patient at 1922.

If M-AI's final Knowledge Base search returns a single CCP-FG, M-AI deploys the CCP-FG's Clinical Care Plan for healthcare implementation for the patient. At 1923, M-AI displays a Suggested Actions Advisory list for the patient-user in the EHEN. M-AI deploys the CCP Plans that do not require professional licensure in narrative format in the Suggested Actions Advisory list 1923. At 1924, M-AI may offer details about each Suggested Actions Advisory list item i, when selected by the patient-user, explaining such details as instructions how to perform the Suggested Actions Advisory list item, frequency of performance.

M-AI deploys the CCP Plans that do require professional licensure for sign off by an appropriately licensed professional, typically, at a remote location. See 1925. Upon licensed professional sign off, M-AI executes items in the Professional Actions Advisory list at 1926, 1927.

M-AI may offer other medical information about the person's clinical status. As shown at 1928, M-AI deploys the diagnosis of the final CCP-FG returned to display information about the diagnosis.

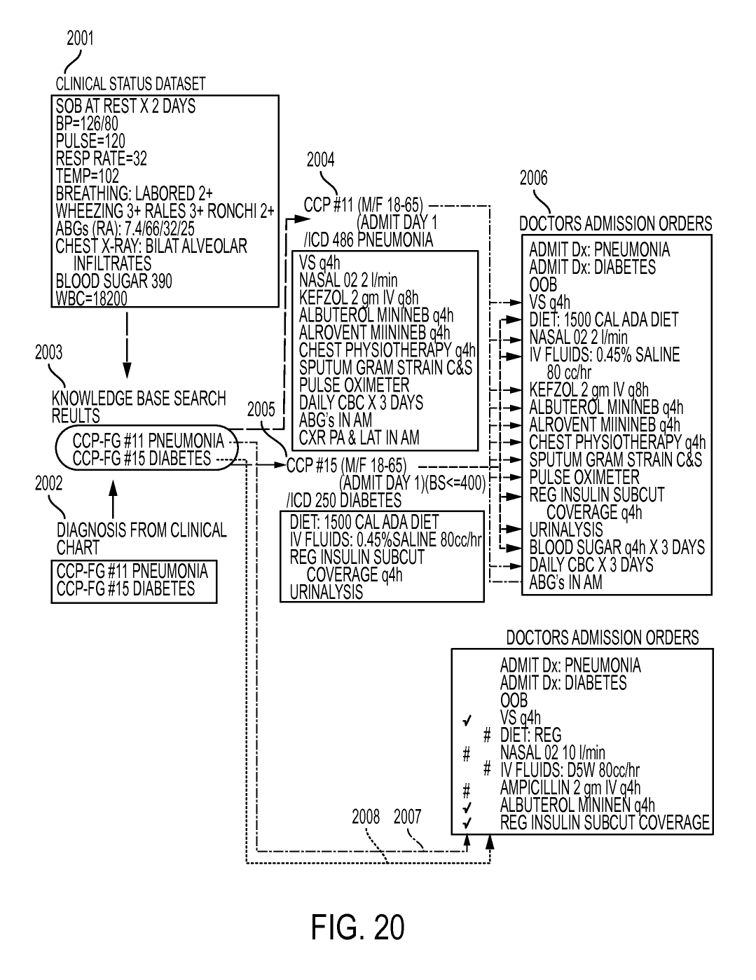

FIG. 20. illustrates the M-AI process of programmatically aiding clinicians in the writing and review of entries in “Doctor Orders” when rendering patient care.

M-AI searches it Patient Database for CCP-FG matches for a patient at a Time Point. The CCP-FG search may be done by the patient's Clinical Status Data Set 2001. Alternately the CCP-FG search may be done by one or more diagnoses 2002 entered in the patient's Electronic Clinical Chart Notes. M-AI deploys the matched CCP-FG's Clinical Care Plans (CCP)s aiding clinicians in the writing and review of entries in “Doctor Orders”. See 2003, 2004, 2005. The clinician-user may select one or more CCP Plans for entry into Doctors Orders 2006. Alternately, M-AI can programmatically deploy the CCP Plans to write all Doctors Orders.

At 2007, 2008 M-AI enables selection of a diagnosis to annotate each order in Doctors Order with a character denoting whether or not the order is appropriate for the selected diagnosis. “✓” character denotes support, a “#” denotes lack of support. “✓” character denotes support, a “#” denotes lack of support. The first column 2007 shows annotation when Pneumonia is selected. The second column 2008 shows annotation when Diabetes is selected.

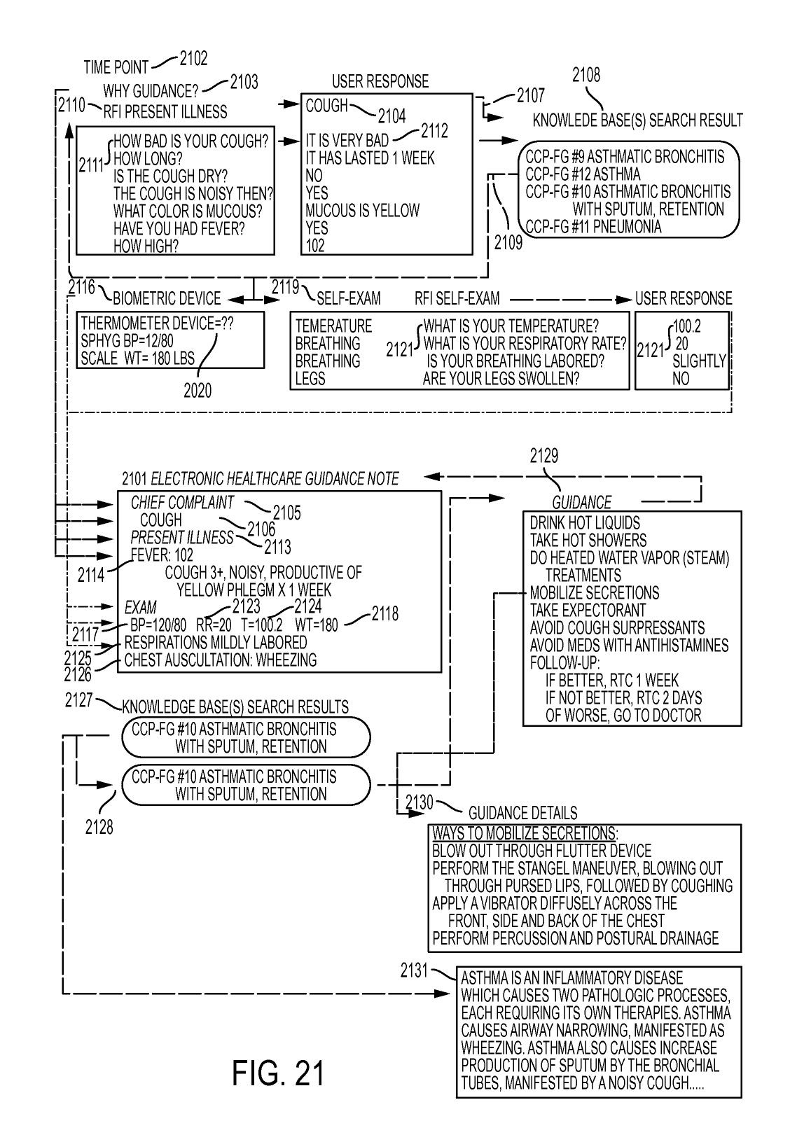

FIG. 21. illustrates the M-AI process of programmatically offering layperson guidance by evaluating the clinical status of the person, for whom guidance is sought, and displaying guidance, by implementing the Clinical Care Plans that are returned as a result of the clinical evaluation.

M-AI deploys the process of layperson guidance as Electronic Healthcare Guidance (EHG) in an Electronic Health Care Guidance Note (EHGN) 2101 for a date and time (Time Point) 2102. M-AI initially prompts the layperson-user at 2103 for the reason for the EHG, “Why guidance?”, which may be a such reasons as a health problem, symptom, illness, lab result or diagnostic test result. M-AI parses the layperson-user narrative response for clinical finding(s) and organizes the clinical finding(s) by its Clinical Hierarchy. M-AI enters the layperson-user Clinical Hierarchy-formatted response in the EHGN under Chief Complaint. See 2104, 2105, 2106. M-AI initiates a Clinical Data Set of the Clinical Hierarchy-formatted response.

At 2107, M-AI searches its Knowledge Base for CCP-FG matches to the Clinical Data Set. CCP-FG matches to the Clinical Data Set are returned at 2108. M-AI programmatically deploys the returned CCP-FG matches to create a Request For Information (RFI) list of items for display to the layperson-user. See 2109, 2110. M-AI may present each RFI item in narrative format.

The layperson-user selects each RFI item 2111 and enters a response 2112. At 2113, 2114, M-AI enters the patient-user the Clinical Hierarchy RFI and response in the EHGN under Present Illness. M-AI adds the Clinical Hierarchy-formatted RFI and response to the Clinical Data Set. M-AI repeats CCP-FG searches with the updated Clinical Data Set and modifies and refreshes the RFI list as a function of the CCP-FGs returned.

M-AI continues the CCP-FG search, RFI modification and refresh cycle until the number of CCP-FG matches are no longer decreasing.

M-AI deploys the CCP-FGs returned from its final Knowledge Base CCP-FG search to determine the required examination of the patient. M-AI then determines the required biometric devices 2116 to perform the examination. M-AI adds each biometric device reading or assessment to the Clinical Data Set. M-AI enters the each biometric device reading or assessment to the in the EHGN under the Exam section 2117, 2118.

M-AI determines requests for information for exam details that cannot be obtained from the available biometric devices 19. Since there is no biometric thermometer reading, M-AI includes an RFI for temperature 2120, 2121.

The layperson-user selects each RFI item and enters a response 2121, 2122. M-AI adds each layperson response to the Clinical Data Set. M-AI enters the Clinical Hierarchy-formatted RFI and layperson-user response in the EHGN under the Exam section. See 2123, 2124, 2125, 2126.

M-AI searches its Knowledge Base for CCP-FG matches to the Clinical Data Set at 2127. M-AI may modify the displayed RFI lists, for the Present Illness and Exam sections as a function of the returned CCP-FG matches. If modifications have been made, M-AI awaits user responses. M-AI repeats this cycle until the number of CCP-FG matches are no longer decreasing.

If M-AI's final Knowledge Base search returns a single CCP-FG. M-AI programmatically processes the returned CCP-FG's Clinical Care Plan (CCP) to display guidance for healthcare actions for the person's clinical status in a Guidance list 2129.

If M-AI's final Knowledge Base search returns more than one CCP-FG, the layperson may toggle though each CCP-FG, usually displayed as the CCP-FG's diagnosis, to review CCP-FG's Guidance.

User selection of a Guidance list item, displays information about the selected item 2130. M-AI also displays information about the CCP-FG's diagnosis 2131.

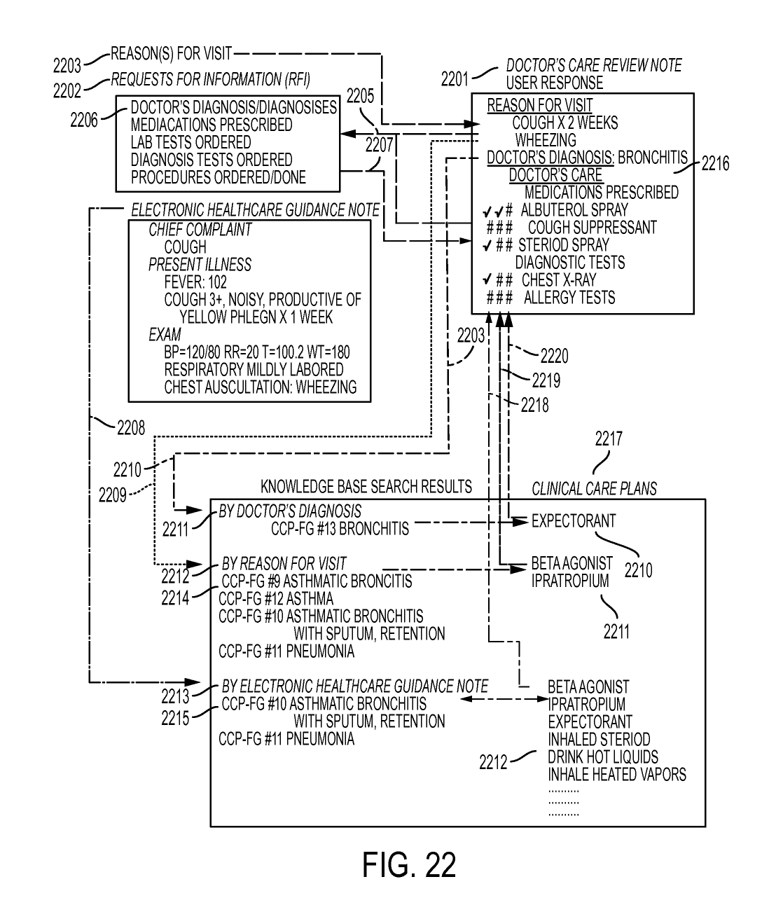

FIG. 22. illustrates the M-AI process of programmatically enabling laypersons to evaluate the healthcare rendered to them or their family by healthcare professionals in clinical patient-clinician encounters.

M-AI deploys the Doctor's Care Review process of enabling laypersons to evaluate the healthcare rendered to them or their family by healthcare professionals in clinical patient-clinician encounters. M-AI creates a Doctor's Care Review Note (DCRN) 2201 to enter layperson-user Clinical Hierarchy-formatted responses to requests for information about the patient-clinician encounter. M-AI creates an RFI list 2202 to inquire about details of the encounter which include request for the diagnosis (diagnoses) given to the patient by the clinician, medications prescribed, lab tests, diagnostic tests and procedures.

M-AI initially prompts the layperson-user at 2203 for the reason(s) for the encounter, which may be a reason such as a health problem, symptom, lab test result, diagnostic test result or diagnosis. M-AI parses the layperson-user narrative response for the reason(s) and organizes the reason(s) by its Clinical Hierarchy. M-AI enters the layperson-user Clinical Hierarchy formatted response 2204 in the Doctor's Care Review Note (DCRN) under “Reason for Visit”. M-AI initiates a Doctor Care Review Data Set of the Clinical Hierarchy formatted response. At 2205, M-AI then searches its Knowledge Base for Clinical Care Plan Findings Groups (CCP-FG)s that match the Doctor Care Review Data Set.

M-AI programmatically deploys the returned CCP-FG matches to create the Request For Information (RFI) list of items 2206 for display to the layperson-user. M-AI may present each RFI item in narrative format. At 2207, M-AI programmatically parses each layperson-user response to an RFI item and organizes the parsed clinical findings by Clinical Hierarchy format to add to the DCRN and Doctor Care Review Data Set. M-AI repeats the CCP-FG search with each update in the Doctor Care Review Data Set for possible modification of the RFI list.

M-AI enables the layperson-user to evaluate the healthcare rendered by the clinician by searching M-AI's Knowledge Base for CCP-FGs that match the last modified Doctor Care Review Data Set. See 2208, 2209, 2210. At 2211, 2212, 2213 M-AI deploys the returned CCP-FGs and CCP-FGs' Clinical Care Plan(s) (CCP)s to evaluate the healthcare rendered as contained in the DCRN.

If the CCP-FG search returns a single CCP-FG, M-AI deploys the CCP-FG's CCP for evaluation. If the CCP-FG search returns more than one CCP-FG, M-AI deploys the CCP by the CCP-FG's diagnosis as selected by the layperson-user. See 2214, 2215.

The layperson-user may select the Doctor's Diagnosis in the DCRN to review the patient's rendered healthcare, which typically returns a single CCP-FG 2211. The layperson-user may select the Reason for Visit in the DCRN to review the patient's rendered healthcare, which may return multiple single CCP-FGs 2212. The layperson-user may select a layperson-user Electronic Healthcare Guidance Note, completed in tandem with the DCRN to review the patient's rendered healthcare, which may return multiple single CCP-FGs 2213. Selection of the Electronic Healthcare Guidance Note typically results in the most clinically comprehensive M-AI evaluation of the healthcare rendered.

M-AI compares the DCRN Doctor's Care items 2216 with the deployed CCP-FG's CCP Plans 2217. M-AI annotates each DCRN specific rendered healthcare item that is CCP-consistent with a character such as “✓”. At 2218, 2219, 2220, M-AI annotates each DCIN Care healthcare item that is not included in the CCP Plans with a character such as “#”.

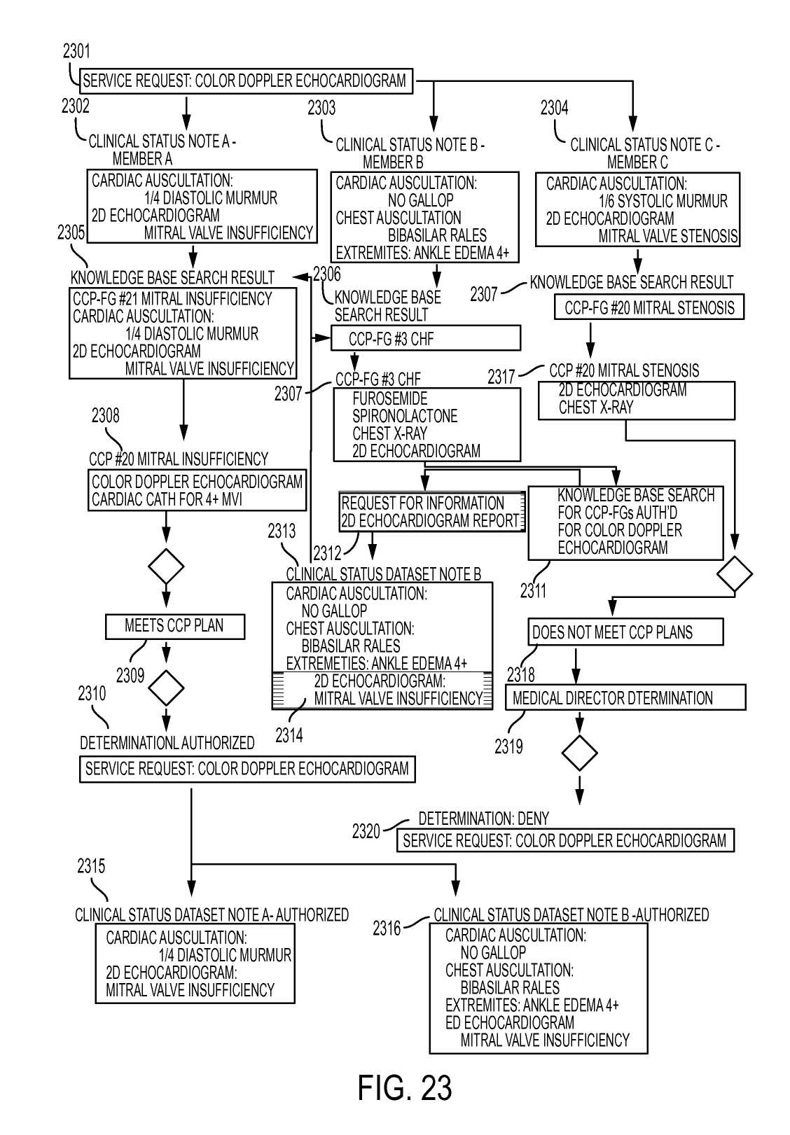

FIG. 23. illustrates an M-AI programmatic process for preservice authorization for a Color Doppler echocardiogram 2301 for three different members. M-AI uploads the clinical status information for each member and parses, Clinical Hierarchy formats and deploys the clinical information for each member as a Clinical Status Data Set. M-AI displays the Clinical Status Data Set in a Clinical Status Note (CSN) for each member 2302, 2303, 2304. The members are new, so M-AI has no additional member clinical information to place into the CSN. M-AI searches its Knowledge Base for CCP-FG matches for each member's Clinical Status Data Set and deploys the search results 2305, 2306, 2307.

For Clinical Status Note A, M-AI returns the CCP-FG with the diagnosis of Mitral insufficiency at 2305. The CCP-FG's CCP Plans 2308 include a Color Doppler Echocardiogram. Therefore, because the CCP Plans include a Color Doppler Echocardiogram, which is the requested service, M-AI determines that the patient's clinical presentation, as contained in CSN A, meets medical necessity. See 2302, 2309. M-AI then programmatically authorizes the requested service at 2310, Color Doppler Echocardiogram.

For Clinical Status Note B, M-AI returns the CCP-FG with the diagnosis of CHF (Congestive Heart Failure). See 2303, 2306. The CCP-FG's CCP Plans 2307 do not include a Color Doppler Echocardiogram. M-AI then searches its Knowledge Base at 2311 for CCP-FGs with CCPs that do contain a Plan for Color Doppler echocardiogram and have been previously authorized for a Color Doppler echocardiogram.

This M-AI search returns CCP-FGs with clinical findings of Cardiac auscultation: diastolic murmur and/or 2D Echocardiogram showing valvular insufficiency.

M-AI notes that CSN B does not contain Cardiac auscultation: diastolic murmur and infers that, in order to consider meeting medical necessity, CSN B needs to contain a 2D echocardiogram. Therefore, at 2312, M-AI creates a Request for Information (RFI) for a 2D echocardiogram.

The provider's response to the RFI that the member's 2D echocardiogram report shows mitral insufficiency. The response is parsed, Clinical Hierarchy formatted and placed in the CSN B. See 2313, 2314. At 2305, 2306 M-AI performs CCP-FG search with the refreshed CSN B and returns a Knowledge Base result of CCP-FG of Mitral insufficiency, as well as CHF.

At 2309, M-AI determines that CSN B now meets medical necessity for a Color Doppler Echocardiogram. M-AI then programmatically authorizes at 2310 the requested service, Color Doppler Echocardiogram.

Because M-AI CSN A and CSN B contain clinical findings that meet medical necessity and have been programmatically authorized, for Color Doppler Echocardiogram, M-AI attaches each CSN with an “Authorized” label at 2315, 2316.

For Clinical Status Note C, M-AI returns the CCP-FG with the diagnosis of Mitral stenosis. See 2304, 2307. The CCP-FG's CCP Plans 2317 do not include a Color Doppler Echocardiogram. M-AI then searches its Knowledge Base for CCP-FGs with CCPs that do contain a Plan for Color Doppler echocardiogram and have been previously authorized for a or Color Doppler echocardiogram. M-AI returns no CCP-FGs. Therefore M-AI does not to create an RFI and determines at 2318 that CSN C does not meet medical necessity for a Color Doppler echocardiogram. At 2319, M-AI programmatically refers CSN C for manual determination by a medical director or nurse. The medical director denies the request for Color Doppler Echocardiogram at 2320. Only a medical director can deny a service request.

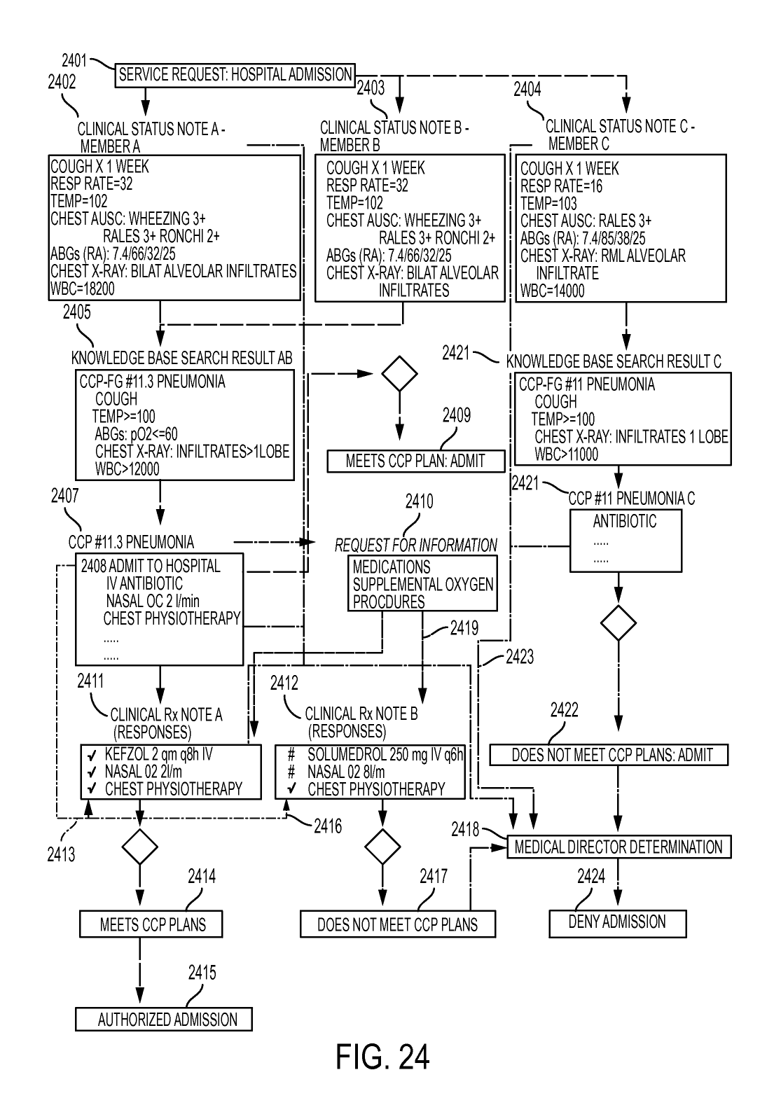

FIG. 24. illustrates an M-AI programmatic process for concurrent authorization request 2401 for an acute Hospital Admission for three members. M-AI uploads the clinical status information for each member and parses, Clinical Hierarchy formats and deploys the clinical information for each member as a Clinical Status Data Set. M-AI displays the Clinical Status Data Set in a Clinical Status Note (CSN) for each member 2402, 2403, 2404. CSN A and CSN B are identical.

For all three CSNs, M-AI returns at 2405, 2406 a Knowledge Base result of a CCP-FG of Pneumonia. The CCP-FG for CSN A and CSN B is the same CCP-FG's CCP-FG “AB”, since the CSN A and CSN B are identical. See 2405. The CCP-FG for CSN C is a different CCP-FG for Pneumonia, CCP-FG “C”, reflecting the fact that CSN C different from CSN A and CSN B. See 2406.

CCP-FG's “AB” CCP “AB” Plans include the Plan “Admit”. Therefore, because CCP “AB” Plans include “Admit to hospital”, M-AI determines at 2409 that the members' clinical presentation, as contained in CSN A and CSN B, each meets medical necessity for Hospital Admission.

M-AI deploys CCP-FG's CCP's “AB” s Plans to create a Request for Information (RFI) 2410 for Member A's and Member B's healthcare providers for clinical information about each member's medical care upon hospital admission. The providers' responses to the RFI are parsed, Clinical Hierarchy formatted and placed in a Clinical Rx Data Set and into a Clinical Rx Note (CRxN) for member A at 2411 and for Member B at 2412.

M-AI searches CCP “AB” Plans for the medical care treatments in Member A's CRxN Clinical Rx Data Set. M-AI′ search returns matches for each treatment. See 2407, 2411, 2413. Therefore, M-AI determines that Member A's CRxN meets medical necessity. Since Member A's clinical presentation and hospital treatments each meet medical necessity 2414, M-AI programmatically authorizes 2415 the Hospital Admission for Member A.

M-AI searches CCP “AB” Plans for the medical care treatments in Member B's CRxN Clinical Rx Data Set. M-AI′ search does not return a match for some of the treatments. See 2407, 2412, 2416. Therefore, M-AI determines that Member B's CRxN does not meet medical necessity. Even though Member B's clinical presentation meets medical necessity, M-AI refers the determination for authorization for the hospital admission to a medical director 2418, because the in-hospital treatments rendered to the member do not meet medical necessity 2417. M-AI displays Clinical Status Note A, Clinical Rx Note A and CCP AB to the medical director for guidance at 2419. The medical director denies the Hospital Admission at 2420. Only a medical director can deny a service request.

CCP-FG's “AB” CCP “AB” Plans include the Plan “Admit”. Therefore, because CCP “AB” Plans include “Admit to hospital”, M-AI determines that the member's' clinical presentation, as contained in CSN A and CSN B, each meets medical necessity for Hospital Admission as noted at 2409.

The CCP-FG for Pneumonia returned for Member C has CCP Plans that do not include the Plan, Admit to hospital. See 2406, 2421. Therefore, M-AI determines that Member C does not meet medical necessity for Hospital Admission. M-AI refers the determination for authorization of the hospital admission to a medical director, because Member C's presentation do not meet medical necessity, as seen at 2422. M-AI displays Clinical Status Note C, and CCP C to the medical director for guidance at 2423.

The medical director denies the Hospital Admission at 2424. Only a medical director can deny a service request.

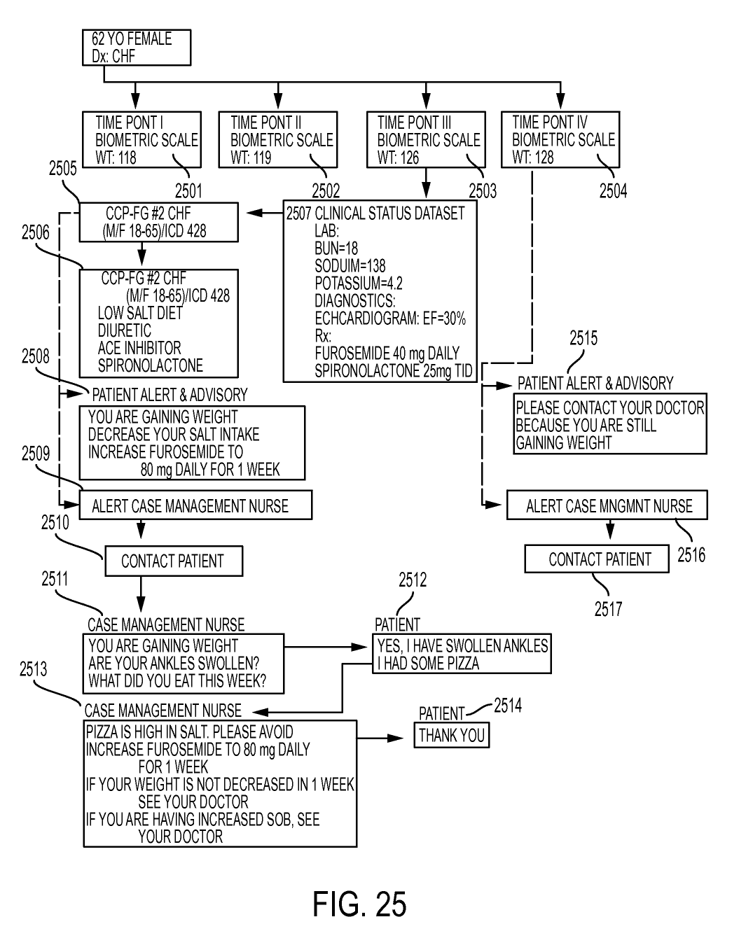

FIG. 25. illustrates the M-AI process for programmatically performing and/or guiding MCO Case Management in a member with the diagnosis of congestive heart failure (CHF) who is being monitoring over multiple time points.

The member is a 62 year old female with the diagnosis of CHF who weighs herself on a biometric scale regularly over time, the results being shown at 2401, 2502, 2503, 2504. M-AI is uploading the biometric scale's weight readings in real time and detects a significant weight gain at Time Point III.

Upon detecting the significant weight gain reading, M-AI determines the members current clinical status by searching its Patient databases for the member's clinical information, parses and organizes the information into its Clinical Hierarchy to create a Clinical Data Set. M-AI searches its Knowledge Base for CCP-FG matches to the member's search for match for the member's Clinical Data Set. M-AI deploys the matching CCP-FG's Clinical Care Plan 2506.

M-AI performs a Patient Alert & Advisory 2508, informing the patient of the weight gain, the implications of the weight gain in CHF, and the healthcare actions needed to combat the weight gain, such as decreasing salt intake and increasing furosemide. M-AI may contact the member electronically, telephonically or by mail.

At 2509, M-AI also alerts the MCO nurse case manager regarding the member's weight gain. The MCO nurse case manager may contact the member to discuss the weight gain and the appropriate healthcare actions to take. See 2510, 2511, 2512, 2513, 2514.

M-AI continues uploading the biometric scale's weight monitoring in real time and detects a significant weight gain at Time Point IV. M-AI again alerts the member and/or the MCO nurse case manager. Since M-AI has detected further weight gain since the previous alert, M-AI performs another Patient Alert & Advisory 2515 to inform the member that the member should contact her doctor (healthcare provider). At 2516, M-AI also alerts the MCO nurse case manager regarding the member's further weight gain. The MCO nurse case manager may contact the member to discuss the further weight gain, as shown at 2517.

Thus, the following and other embodiments have been disclosed.

In an embodiment, a computer implemented software method and system performs medical artificial intelligence by compiling, collating and organizing electronically stored and entered clinical information in patient clinical databases into an electronic format, on a continuous and ongoing process, that enables side-by-side comparisons of patients' clinical findings to enable tracking of the clinical findings over patients' clinical courses in order to determine the better clinical outcomes and to learn, by deductive and inferential logic, the clinical interventions that produce, these better clinical outcomes.

In an embodiment, a computer implemented software method and system performs medical artificial intelligence by compiling, collating and organizing electronically stored clinical information in patient clinical databases into an electronic format, on a continuous and ongoing process, that learns, by deductive and inferential logic, the patient clinical presentations, consisting of the clinical presentations' grouped clinical findings which are associated with the clinical interventions that produce the better clinical outcomes.

In an embodiment, a computer implemented software method and system parses electronic clinical data in narrative format to identify and extract the clinical terms within the narrative format, by using word indicators that identify and enable placement of the clinical terms into a four level non-linear branching tree Clinical Hierarchy.

In an embodiment, a computer implemented software method and system performs medical artificial intelligence by programmatically parsing the stored clinical information in patient clinical databases that is in narrative format for clinical terms and placing the clinical terms into a four level non-linear branching tree Clinical Hierarchy to enable programmatic searches of the stored clinical information by similarly parsed and Clinical Hierarchy-formatted clinical findings of the clinical presentations or clinical status of the individual persons or patients for whom the learned knowledge is being applied.

In an embodiment, a computer implemented software method and system performs medical artificial intelligence by deploying the learned clinical interventions associated with the learned grouped clinical findings that most closely match the results of searches of the clinical presentations or clinical status of the individual persons or patients for whom the learned knowledge is being applied, for guidance and implementation of the interventions.

In an embodiment, a computer implemented software method and system performs medical artificial intelligence by deploying the learned grouped clinical findings that most closely match the results of searches of the clinical presentations or clinical status of the individual persons or patients for whom the learned knowledge is being applied to make programmatic prompts and requests from users for additional clinical information to enable more focused repeat searches.

In an embodiment, a computer implemented software method and system that performs medical artificial intelligence by deploying the learned grouped clinical findings that most closely match the results of searches of the clinical presentations or clinical status of the individual persons or patients for whom the learned knowledge is being applied to make programmatic determinations for recruiting biometric devices and deploying the biometric devices' electronic readings, of the individual person or patient for whom the learned knowledge is being applied, to obtain additional clinical information to enable more focused repeat searches.

In an embodiment, a method and system computer software performs medical artificial intelligence for clinicians in patient-clinician encounters to enhance the clinicians' clinical evaluation of their patients and to guide the planning and delivery of healthcare for their patients, by searching its learned grouped clinical findings that most closely match their patients' clinical presentations or clinical status and deploying the search results to guide the clinicians' planning of their patients' healthcare actions, to enhance the clinical evaluation of their patients, by evaluating consistency of clinicians' diagnoses with entered patient clinical findings, consistency of planned healthcare actions with entered patient clinical findings and diagnoses, for displaying differential diagnoses and for prompts for additional patient clinical information needed to support clinicians' diagnoses.

In an embodiment, a method and system computer software performs medical artificial intelligence with the goal to guide healthcare toward improved health outcomes that compiles, collates and organizes the stored clinical information of patients, in a continuous and ongoing process, to determine the healthcare visit attributes, such as frequency, intensity and type, of their patient-clinician encounters and to learn the interventions that are associated with fewer and less intense patient-clinician encounters for patients with similar clinical presentations.

In an embodiment, a method and system computer software performs medical artificial intelligence for laypersons by enabling laypersons to assess their own clinical status and to deploy the clinical status assessment to implement healthcare actions independent of clinical patient-clinician direct encounters, by searching its learned grouped clinical findings that most closely match the clinical information entered by the layperson and deploying the search results for additional clinical information to narrow down the search results and to deploy the search results' interventions as healthcare actions to be implemented by the laypersons.

In an embodiment, a method and system computer software performs medical artificial intelligence for laypersons by enabling laypersons to undergo electronic clinical status evaluation and examination, independent of clinicians, and to obtain healthcare actions as a result of the electronic clinical status evaluation and examination, by a process which is similar to clinicians' patient evaluations, by making serial requests for information from the layperson and performing serial searches of its learned grouped clinical findings after each layperson response to learn about the laypersons' illness and then repeats serial searches of its learned grouped clinical findings and uses the search results to determine the clinical examination required and advises the layperson of which biometric devices are needed and directions as to use of the biometric device and, after receiving electronic input of each biometric device, then repeats serial searches of its learned grouped clinical findings for any additional needed biometric devices and then repeats serial searches of its learned grouped clinical findings and deploys the search results' interventions as healthcare actions to be implemented by and for the layperson. Healthcare actions requiring performance by licensed clinicians may be signed off by remotely situated clinicians, who are appropriately licensed.

In an embodiment, a method and system computer software performs medical artificial intelligence for laypersons by enabling laypersons to assess the healthcare rendered by their healthcare providers, by making serial requests for information about the reasons for the visit to the healthcare provider and by serial searches of its learned grouped clinical findings that most closely match the clinical information entered by the layperson and deploying the search results for additional clinical information to narrow down the search results and to deploy the search results' interventions for programmatic comparison for clinical appropriateness to the healthcare actions performed by the layperson's healthcare provider, as entered by the layperson.

In an embodiment, a method and system computer software performs medical artificial intelligence that aids in the writing and reviewing of Doctor Orders for orders that are medically appropriate for patients' clinical status by serial searches of its learned grouped clinical findings that most closely match the patient's clinical status. as entered in Electronic Clinical chart notes, and deploying the search results' interventions to enable clinicians to confirm clinical appropriateness of their orders, or to programmatically use the interventions to write orders in Doctors Orders, with sign off by a clinician.

In an embodiment, a method and system computer software that performs medical artificial intelligence for Managed Care Organizations (MCO), by serial searches of its learned grouped clinical findings that most closely match members' clinical status and deploying the search results' interventions to automatically authorize utilization review requests for clinical services when the requested service is included in the search results' interventions or to guide MCO doctors and nurses in making utilization review determinations; deploying the search results' interventions to automatically authorize or guide claims payments; deploying the search results' interventions for MCO nurse case management of members with complex health issues; and deploying the search results' interventions for quality care reviews, comparing the search results' interventions with the healthcare services rendered by their members' clinicians.

At least some aspects disclosed herein can be embodied, at least in part, in software. That is, the techniques may be carried out in a special purpose or general purpose computer system or other data processing system in response to its processor, such as a microprocessor, executing sequences of instructions contained in a memory, such as ROM, volatile RAM, non-volatile memory, cache or a remote storage device. Functions expressed in the claims may be performed by a processor in combination with memory storing code and should not be interpreted as means-plus-function limitations.

Routines executed to implement the embodiments may be implemented as part of an operating system, firmware, ROM, middleware, service delivery platform, SDK (Software Development Kit) component, web services, or other specific application, component, program, object, module or sequence of instructions referred to as “computer programs.” Invocation interfaces to these routines can be exposed to a software development community as an API (Application Programming Interface). The computer programs typically comprise one or more instructions set at various times in various memory and storage devices in a computer, and that, when read and executed by one or more processors in a computer, cause the computer to perform operations necessary to execute elements involving the various aspects.

A machine-readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer-to-peer networks. Different portions of the data and instructions can be obtained from different centralized servers and/or peer-to-peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine-readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others.

In general, a machine readable medium includes any mechanism that provides (e.g., stores) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

The above embodiments and preferences are illustrative of the present invention. It is neither necessary, nor intended for this patent to outline or define every possible combination or embodiment. The inventor has disclosed sufficient information to permit one skilled in the art to practice at least one embodiment of the invention. The above description and drawings are merely illustrative of the present invention and that changes in components, structure and procedure are possible without departing from the scope of the present invention as defined in the following claims. For example, elements and/or steps described above and/or in the following claims in a particular order may be practiced in a different order without departing from the invention. Thus, while the invention has been particularly shown and described with reference to embodiments thereof, it will be understood by those skilled in the art that various changes in form and details may be made therein without departing from the spirit and scope of the invention.

What is claimed is:

1. An electronic medical system, comprising:
a) a data store including data representing a plurality of clinical care plan findings groups associated with a corresponding plurality of clinical care plans, each clinical care plan findings group being clinical hierarchy formatted and each clinical care plan comprising a respective plurality of medical interventions; and
b) a computer processor coupled to the data store and in communication with data representing an electronic clinical chart note having clinical findings for a specific patient therein, the computer processor being programmed to:
organize said clinical findings in the electronic clinical chart note by clinical hierarchy to create clinical hierarchy-formatted clinical findings;
group the clinical hierarchy-formatted clinical findings into a clinical status data set;
use said clinical status data set to search the data store to identify at least one matching clinical care plan findings group;
transform said data representing said electronic clinical chart note by adding a first plurality of medical interventions in a first clinical care plan associated with the matching clinical care plan findings group to the electronic clinical chart note.

2. The electronic medical system according to claim 1, wherein the computer processor is further programmed to identify a first clinical care plan findings group that matches a second clinical care plan findings group, and to combine said first clinical care plan findings group and said second clinical care plan findings group to create a new clinical care plan findings group in said data store.

3. The electronic medical system according to claim 2, wherein the new clinical care plan findings group comprises each finding in the first clinical care plan findings group and each finding in the second clinical care plan findings group.

4. The electronic medical system according to claim 2, wherein said processor is programmed to match the first clinical care plan findings group with the second clinical care plan findings group based on a matching clinical care plan.

5. The electronic medical system according to claim 2, wherein said processor is programmed to match the first clinical care plan findings group with the second clinical care plan findings group based on matching demographics.

6. The electronic medical system according to claim 2, wherein said processor is programmed to match the first clinical care plan findings group with the second clinical care plan findings group based on matching diagnosis.

7. The electronic medical system according to claim 2, wherein said processor is programmed to match the first clinical care plan findings group with the second clinical care plan findings group based on a matching clinical care plan, matching demographics, and matching diagnosis.

8. The electronic medical system according to claim 2, wherein said processor is programmed to match the first clinical care plan findings group with the second clinical care plan findings group by performing serial searches of the data store for permutations and combinations of subsets of clinical findings in the first clinical care plan findings group.

9. The electronic medical system according to claim 2, wherein said processor is programmed to match the first clinical care plan findings group with the second clinical care plan findings group by performing serial searches of the data store for subsets of clinical findings in the first clinical care plan findings group.

10. The electronic medical system according to claim 1, wherein said processor is programmed to identify clinical interventions that produce better patient clinical outcomes and use said identified clinical interventions to create a new clinical care plan.

11. The electronic medical system according to claim 1, wherein said processor is programmed to identify said clinical interventions by:
searching said data store to identify a plurality of clinical course sets, each clinical course set comprising a compilation of similar patient clinical courses;
comparing a first findings set associated with a first clinical course set with a second findings set associated with a second clinical course set to identify improvements of varying degree;
identifying the second clinical course set as a best clinical course set based on a degree of improvement associated with said second clinical course set; and,
storing an identification of the second clinical course set as the best clinical course in the data store.

12. The electronic medical system according to claim 11, wherein said processor is programmed to use the stored identification of the best clinical course to transform said data representing said electronic clinical chart note by adding a second plurality of medical interventions to the electronic clinical chart note.

13. The electronic medical system according to claim 11, wherein said processor is programmed to use the stored identification of the best clinical course to identify the matching clinical care plan findings group.

14. The electronic medical system according to claim 11, wherein said processor is programmed to identify the best clinical course set and store the identification repetitively over time, whereby medical interventions utilized by clinicians and by the system produce improved clinical outcomes over time.

15. The electronic medical system according to claim 11, wherein said processor is programmed to compare the first findings set with the second findings set across a plurality of time points.

16. The electronic medical system according to claim 1, wherein said at least one matching clinical care plan findings group comprises a plurality of matching clinical care plan findings groups, and said processor is further programmed to:
issue a request for information;
receive a response to said request for information;
use said response to said request for information to disqualify at least one of the plurality of matching clinical care plan findings groups.

17. The electronic medical system according to claim 16, wherein the request for information is a request to deploy a biometric device.

18. The electronic medical system according to claim 1, wherein said at least one matching clinical care plan findings group comprises a plurality of matching clinical care plan findings groups, and said processor is further programmed to:
identify at least one clinical finding that is not in said electronic clinical chart note and is useful to identify said at least one matching clinical care plan findings group;
issue a prompt to a clinician for said at least one clinical finding;
receive a response to said prompt;
use said response to said prompt to disqualify at least one of the plurality of matching clinical care plan findings groups.

19. An electronic medical system, comprising:
a) a data store including data representing a plurality of clinical care plan findings groups associated with a corresponding plurality of clinical care plans, each clinical care plan findings group being clinical hierarchy formatted and each clinical care plan comprising a respective plurality of medical interventions; and
b) a computer processor coupled to the data store and programmed to:
identify a first clinical care plan findings group that matches a second clinical care plan findings group based on a matching clinical care plan, matching demographics, and matching diagnosis;
combine said first clinical care plan findings group and said second clinical care plan findings group to create a new clinical care plan findings group; and,
store said new clinical care plan findings group in said data store.

20. The electronic medical system according to claim 19, wherein the new clinical care plan findings group comprises each finding in the first clinical care plan findings group and each finding in the second clinical care plan findings group.

21. The electronic medical system according to claim 19, wherein said processor is programmed to match the first clinical care plan findings group with the second clinical care plan findings group by performing serial searches of the data store for permutations and combinations of subsets of clinical findings in the first clinical care plan findings group.

22. The electronic medical system according to claim 19, wherein said processor is programmed to match the first clinical care plan findings group with the second clinical care plan findings group by performing serial searches of the data store for subsets of clinical findings in the first clinical care plan findings group.

23. An electronic medical system, comprising:
a) a data store including data representing a plurality of clinical care plan findings groups associated with a corresponding plurality of clinical care plans, each clinical care plan findings group being clinical hierarchy formatted and each clinical care plan comprising a respective plurality of medical interventions; and
b) a computer processor coupled to the data store and programmed to identify clinical interventions that produce better patient clinical outcomes and use said identified clinical interventions to create a new clinical care plan by:
searching said data store to identify a plurality of clinical course sets, each clinical course set comprising a compilation of similar patient clinical courses;
comparing a first findings set associated with a first clinical course set with a second findings set associated with a second clinical course set to identify improvements of varying degree;
identifying the second clinical course set as a best clinical course set based on a degree of improvement associated with said second clinical course set; and,
using the second clinical course set to create a new clinical care plan; and,
storing the new clinical care plan in the data store.

24. The electronic medical system according to claim 23, wherein said processor is programmed to use the stored identification of the second clinical course set as the best clinical course to transform said data representing said electronic clinical chart note by adding a second plurality of medical interventions to the electronic clinical chart note.

25. The electronic medical system according to claim 23, wherein said processor is programmed to use the stored identification of the second clinical course set as the best clinical course to identify the matching clinical care plan findings group.

26. The electronic medical system according to claim 23, wherein said processor is programmed to identify the best clinical course set and store the identification repetitively over time, whereby medical interventions utilized by clinicians produce improved clinical outcomes over time.

27. The electronic medical system according to claim 23, wherein said processor is programmed to compare the first findings set with the second findings set across a plurality of time points.

28. An electronic medical system, comprising:
a) a data store including data representing a plurality of sets of clinical data in narrative format; and
b) a computer processor coupled to the data store, the computer processor being programmed to:
parse each of the plurality of sets of clinical data in narrative format to identify and extract clinical terms within the narrative format by using word indicators that identify and enable placement of said clinical terms into a four-level non-linear branching tree clinical hierarchy.

29. The electronic medical system according to claim 28, wherein said processor is further programmed to:
organize said clinical findings in at least one of the sets of clinical data by clinical hierarchy to create clinical hierarchy-formatted clinical findings;
group the clinical hierarchy-formatted clinical findings into a clinical status data set;
use said clinical status data set to search the data store to identify a matching clinical care plan findings group; and,
transform data in at least one of the plurality of sets of clinical data in narrative format by adding a first plurality of medical interventions in a first clinical care plan associated with the matching clinical care plan findings group to the at least one set of clinical data in narrative format.

30. An electronic medical system, comprising:
a) a data store including data representing a plurality of sets of clinical data in narrative format; and
b) a computer processor coupled to the data store, the computer processor being programmed to:
parse one of a plurality of sets of clinical data in narrative format for clinical terms;
place the clinical terms into a four-level non-linear branching tree clinical hierarchy in a second clinical data set;
repeating the parsing and placing into hierarchy for further ones of the plurality of sets of clinical data in narrative format;
programmatically searching the stored second clinical data set using similarly parsed and clinical hierarchy-formatted clinical findings of clinical presentations or clinical status of the individual persons or patients.
